(19) United States
(12) Patent Application Publication
(10) Pub. No.: US 2025/0157340 A1
(43) Pub. Date: May 15, 2025

(54) CONTROLLING MANNED VTOL AERIAL VEHICLES

(71) Applicant: ALAUDA AERONAUTICS PTY LTD, Beverley (AU)

(72) Inventors: Florian BREUT, Beverley (AU); Matthew James PEARSON, Beverley (AU)

(73) Assignee: ALAUDA AERONAUTICS PTY LTD, Beverley (AU)

(21) Appl. No.: 18/713,391

(22) PCT Filed: Nov. 24, 2022
(86) PCT No.: PCT/AU2022/051409

§ 371 Date: May 24, 2024

(30) Foreign Application Priority Data
Nov. 24, 2021 (AU) 2021903795

(51) Int. Cl. G08G 5/265; B64C 29/00; B64D 43/00; G08G 5/23; G08G 5/54; G08G 5/59

(52) U.S. Cl. CPC G08G 5/265; B64C 29/0091; B64D 43/00; G08G 5/23; G08G 5/54; G08G 5/59

(57) ABSTRACT

Embodiments relate generally to systems and VTOL aerial vehicles. An example central server system comprises: at least one central server system processor; and central server system memory storing central server system program instructions accessible by the at least one central server system processor, and configured to cause the at least one central server system processor to: receive vehicle registration data associated with a manned VTOL aerial vehicle; and determine that the vehicle registration data is associated with a manned VTOL aerial vehicle that is authorized to communicate with the central server system. Some embodiments include VTOL aerial vehicles in communication or communicable with a central server system.

### TECHNICAL FIELD

Embodiments of this disclosure generally relate to aerial vehicles. Embodiments of this disclosure relate to aerial vehicle systems and system infrastructure. In some embodiments, such systems can be used for controlling aerial vehicles.

### BACKGROUND

Aerial vehicles, such as manned vertical take-off and landing (VTOL) aerial vehicles can be controllably propelled within three-dimensional space. In some cases, a manned VTOL aerial vehicle can, for example, be controllably propelled within three-dimensional space that is physically restricted (e.g. indoors) or between walls or other objects. Alternatively, the manned VTOL aerial vehicle can be controllably propelled within artificially restricted three-dimensional space, for example, at heights dictated by an air-traffic controller, or other artificial restriction.

Manned VTOL aerial vehicles may also collide with objects such as birds, walls, buildings or other aerial vehicles during flight. Collision with an object can cause damage to the aerial vehicle, particularly when the aerial vehicle is traveling at a high speed. Furthermore, collisions can be dangerous to people or objects nearby that can be hit by debris or the aerial vehicle itself. This can be a particularly large issue when high density airspace is considered.

A relatively large amount of aerial vehicles may fly through similar airspace and may travel along transverse flightpaths, increasing risks associated with collisions. Some of these aerial vehicles may be authorised to fly in the airspace and some may not be authorised to fly in the airspace. Aerial vehicles may also collide with objects because of other factors such as poor visibility, pilot error, reckless or unauthorised pilot behaviour or slow pilot reaction time.

Infrastructure that is installed in or near the three-dimensional space within which the manned VTOL aerial vehicle is to fly can be used to assist with navigation of the manned VTOL aerial vehicle during flight.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

In some embodiments, there is provided a central server system. The central control system may comprise: at least one central server system processor; and central server system memory storing central server system program instructions accessible by the at least one central server system processor, and configured to cause the at least one central server system processor to: receive vehicle registration data associated with a manned VTOL aerial vehicle; and determine that the vehicle registration data is associated with a manned VTOL aerial vehicle that is authorized to communicate with the central server system.

In some embodiments, the central control system further comprises a central server system communication system; wherein the central server system program instructions are further configured to cause the at least one central server system processor to receive the vehicle registration data using the central server system communication system.

In some embodiments, the vehicle registration data comprises one or more of vehicle identification data and vehicle performance data; and the vehicle performance data comprises one or more of vehicle sensor data, vehicle diagnostic data, vehicle firmware data and pilot biometric data.

In some embodiments, in response to determining that the manned VTOL aerial vehicle is authorized to communicate with the central server system, the central server system program instructions are configured to cause the at least one central server system processor to determine central server system data.

In some embodiments, the central server system program instructions are further configured to cause the at least one central server system processor to transmit the central server system data.

In some embodiments, the central server system program instructions are configured to cause the at least one central server system processor to transmit the central server system data using the central server system communication system.

In some embodiments, the central server system memory stores a three-dimensional model of a region; and the central server system data comprises an updated three-dimensional model of the region.

In some embodiments, the central server system data comprises an object state estimate that is indicative of a state of an object.

In some embodiments, the central server system data comprises an object state estimate confidence metric that is indicative of an error associated with the object state estimate.

In some embodiments, the central server system data comprises vehicle control data configured to be executed by the at least one processor to control the manned VTOL aerial vehicle.

In some embodiments, the central server system program instructions are configured to cause the at least one central server system processor to: compare the vehicle performance data to an operational condition; determine that the vehicle registration data satisfies the operational condition; and determine a vehicle landing position vector; and the central server system data comprises the vehicle landing position vector.

In some embodiments, there is provided a system. The system may comprise: the central server system; and the manned VTOL aerial vehicle, wherein the manned VTOL aerial vehicle comprises: a body comprising a cockpit; a propulsion system carried by the body to propel the body during flight; and a control system configured to enable control of the propulsion system.

In some embodiments, the manned VTOL aerial vehicle comprises a communication system; and the control system comprises: at least one processor; and memory storing program instructions accessible by the at least one processor, and configured to cause the at least one processor to: retrieve, from the memory, the vehicle registration data; and transmit the vehicle registration data using the communication system.

In some embodiments, the control system comprises a sensing system configured to generate sensor data; and the vehicle registration data comprises the sensor data.

In some embodiments, the sensing system comprises a Global Navigation Satellite System (GNSS) module configured to generate GNSS data that is indicative of a current position of the manned VTOL aerial vehicle; and the sensor data comprises the GNSS data.

In some embodiments, the sensing system comprises a propulsion system sensing system that is configured to generate propulsion system data that is associated with the propulsion system; and the sensor data comprises the propulsion system data.

In some embodiments, the sensor data comprises diagnostic data indicative of a state of one or more vehicle on-board systems.

In some embodiments, the program instructions are further configured to cause the at least one processor to receive the central server system data using the vehicle communication system.

In some embodiments, the central server system data comprises control data; and the program instructions are configured to cause the at least one processor to control the propulsion system based at least in part on the control data.

In some embodiments, the control data comprises a landing position vector and the program instructions are configured to cause the at least one processor to autonomously control the propulsion system to land the manned VTOL aerial vehicle within a landing zone that is associated with the landing position vector.

In some embodiments, the system further comprises an autonomous vehicle comprising: an autonomous vehicle propulsion system; at least one autonomous vehicle processor; and autonomous vehicle memory storing autonomous vehicle program instructions accessible by the at least one autonomous vehicle processor, and configured to cause the at least one autonomous vehicle processor to: receive the central server system data; and control the autonomous vehicle propulsion system, based at least in part on the central server system data.

In some embodiments, there is provided a manned VTOL aerial vehicle. The manned VTOL aerial vehicle may comprise: a body comprising a cockpit; a propulsion system carried by the body to propel the body during flight; pilot-operable controls accessible from the cockpit; and a control system configured to receive input from the pilot-operable controls and to perform autonomous control functions, the control system comprising: at least one processor; and memory storing program instructions accessible by the at least one processor, and configured to cause the at least one processor to: determine that vehicle data satisfies an operational condition; determine a landing position vector in response to determining that the vehicle data satisfies the operational condition; and autonomously control the propulsion system to land the manned VTOL aerial vehicle within a landing zone that is associated with the landing position vector.

In some embodiments, there is provided a manned VTOL aerial vehicle. The manned VTOL aerial vehicle may comprise: a body comprising a cockpit; a propulsion system carried by the body to propel the body during flight; a user interface comprising pilot-operable controls accessible from the cockpit; and a control system comprising: at least one processor; and memory storing program instructions accessible by the at least one processor, and configured to cause the at least one processor to: determine that vehicle data satisfies an operational condition; determine a landing position vector in response to determining that the vehicle data satisfies the operational condition; determine a user interface output based at least in part on the landing position vector; and output the user interface output using the user interface.

In some embodiments, the user interface output comprises one or more of an audio output and a visual output.

In some embodiments, the vehicle data is associated with the manned VTOL aerial vehicle.

In some embodiments, the manned VTOL aerial vehicle further comprises a vehicle communication system.

In some embodiments, the program instructions are further configured to cause the at least one processor to transmit the vehicle data using the vehicle communication system.

In some embodiments, the program instructions are further configured to cause the at least one processor to determine vehicle transmission data, the vehicle transmission data being indicative of the vehicle data satisfying the operational condition.

In some embodiments, the program instructions are further configured to cause the at least one processor to transmit the vehicle transmission data using the vehicle communication system.

In some embodiments, the vehicle transmission data comprises the landing position vector.

In some embodiments, there is provided a system. The system may comprise: the manned VTOL aerial vehicle; and a central server system comprising: a central server system communication system; at least one central server system processor; and central server system memory storing central server system program instructions accessible by the at least one central server system processor, and configured to cause the at least one central server system processor to: receive the vehicle transmission data using the central server system communication system; determine central server system data; and transmit the central server system data using the central server system communication system.

In some embodiments, the central server system memory stores a three-dimensional model of a region; and determining the central server system data comprises determining an updated three-dimensional model of the region.

In some embodiments, determining the central server system data comprises determining a second landing position vector associated with a second manned VTOL aerial vehicle.

In some embodiments, the central server system program instructions are configured to cause the at least one central server system processor to determine the second landing position vector based at least in part on the landing position vector.

In some embodiments, the landing position vector and the second landing position vector are different.

In some embodiments, the landing position vector and the second landing position vector are the same.

In some embodiments, there is provided a system. The system may comprise: the manned VTOL aerial vehicle; and a second manned VTOL aerial vehicle comprising: a second body comprising a second cockpit; a second propulsion system carried by the second body to propel the second body during flight; a second user interface comprising second pilot-operable controls accessible from the second cockpit; a second vehicle communication system; a second control system comprising: at least one second processor; and second memory storing second program instructions accessible by the at least one second processor, and configured to cause the at least one second processor to: receive the vehicle data using the second vehicle communication system; and determine a second landing position vector, based at least in part on the vehicle data; and control the propulsion system to land the manned VTOL aerial vehicle within a second landing zone that is associated with the second landing position vector.

In some embodiments, there is provided a system. The system may comprise: the manned VTOL aerial vehicle; and a second manned VTOL aerial vehicle comprising: a second body comprising a second cockpit; a second propulsion system carried by the second body to propel the second body during flight; a second user interface comprising second pilot-operable controls accessible from the second cockpit; a second vehicle communication system; a second control system comprising: at least one second processor; and second memory storing second program instructions accessible by the at least one second processor, and configured to cause the at least one second processor to: receive the central server system data using the second vehicle communication system; and control the propulsion system to land the manned VTOL aerial vehicle within a second landing zone that is associated with the second landing position vector.

In some embodiments, there is provided a system. The system may comprise: the manned VTOL aerial vehicle; and a second manned VTOL aerial vehicle comprising: a second body comprising a second cockpit; a second propulsion system carried by the second body to propel the second body during flight; a second user interface comprising second pilot-operable controls accessible from the second cockpit; a second vehicle communication system; a second control system comprising: at least one second processor; and second memory storing second program instructions accessible by the at least one second processor, and configured to cause the at least one second processor to: receive the vehicle data using the second vehicle communication system; determine a second user interface output, based at least in part on the vehicle data; and output the second user interface output using the second user interface.

In some embodiments, there is provided a system. The system may comprise: the manned VTOL aerial vehicle; and a second manned VTOL aerial vehicle comprising: a second body comprising a second cockpit; a second propulsion system carried by the second body to propel the second body during flight; a second user interface comprising second pilot-operable controls accessible from the second cockpit; a second vehicle communication system; a second control system comprising: at least one second processor; and second memory storing second program instructions accessible by the at least one second processor, and configured to cause the at least one second processor to: receive the vehicle transmission data using the second vehicle communication system; determine a second user interface output, based at least in part on the vehicle transmission data; and output the second user interface output using the second user interface.

In some embodiments, the second user interface output is associated with the second landing position vector.

In some embodiments, the second user interface output comprises one or more of a second audio output and a second visual output.

In some embodiments, there is provided a system. The system may comprise: the manned VTOL aerial vehicle; and an autonomous vehicle comprising: an autonomous vehicle propulsion system; at least one autonomous vehicle processor; and autonomous vehicle memory storing program instructions accessible by the at least one autonomous vehicle processor, and configured to cause the at least one autonomous vehicle processor to: receive the vehicle transmission data; and control the autonomous vehicle propulsion system, based at least in part on the vehicle transmission data.

In some embodiments, there is provided a central server system. The central server system may comprise: a central server system communication system; at least one central server system processor; and central server system memory storing central server system program instructions accessible by the at least one central server system processor, and configured to cause the at least one central server system processor to: receive vehicle data that is associated with a manned VTOL aerial vehicle; determine that the vehicle data satisfies an operational condition; determine central server system data in response to determining that the vehicle data satisfies an operational condition; and transmit the central server system data using the central server system communication system.

In some embodiments, the central server system data comprises a landing position vector.

In some embodiments, the central server system memory stores a three-dimensional model of a region; and the central server system data comprises an updated three-dimensional model of the region.

In some embodiments, the central server system program instructions are configured to cause the at least one central server system processor to determine the updated three-dimensional model of the region based at least in part on the landing position vector.

In some embodiments, the central server system data comprises restriction condition data.

In some embodiments, the central server system program instructions are configured to cause the at least one central server system processor to determine the restriction condition data based at least in part on the landing position vector.

In some embodiments, the central server system data comprises a user interface output.

In some embodiments, the central server system program instructions are configured to cause the at least one central server system processor to determine the user interface output based at least in part on the landing position vector.

In some embodiments, there is provided a system. The system may comprise: the central server system, and the manned VTOL aerial vehicle, wherein the manned VTOL aerial vehicle comprises: a body comprising a cockpit; a propulsion system carried by the body to propel the body during flight; pilot-operable controls accessible from the cockpit; a control system configured to receive input from the pilot-operable controls and to perform autonomous control functions, the control system comprising: at least one processor; and memory storing program instructions accessible by the at least one processor, and configured to cause the at least one processor to: receive the central server system data; and autonomously control the propulsion system to land the manned VTOL aerial vehicle within a landing zone that is associated with the landing position vector.

In some embodiments, there is provided a system. The system may comprise: the central server system, and the manned VTOL aerial vehicle, wherein the manned VTOL aerial vehicle comprises: a body comprising a cockpit; a propulsion system carried by the body to propel the body during flight; a user interface comprising pilot-operable controls accessible from the cockpit; a control system configured to receive input from the pilot-operable controls and to perform autonomous control functions, the control system comprising: at least one processor; and memory storing program instructions accessible by the at least one processor, and configured to cause the at least one processor to: receive the central server system data; determine a user interface output based at least in part on the landing position vector; and output the user interface output using the user interface.

In some embodiments, the user interface output comprises one or more of an audio output and a visual output.

In some embodiments, the system further comprises an autonomous vehicle comprising: an autonomous vehicle propulsion system; at least one autonomous vehicle processor; and autonomous vehicle memory storing program instructions accessible by the at least one autonomous vehicle processor, and configured to cause the at least one autonomous vehicle processor to: receive the central server system data; and control the autonomous vehicle propulsion system, based at least in part on the landing position vector.

In some embodiments, there is provided a system. The system may comprise: the central server system, and a second manned VTOL aerial vehicle, wherein the second manned VTOL aerial vehicle comprises: a second body comprising a second cockpit; a second propulsion system carried by the body to propel the second body during flight; second pilot-operable controls accessible from the second cockpit; a second control system configured to receive input from the second pilot-operable controls and to perform autonomous control functions, the second control system comprising: at least one second processor; and second memory storing second program instructions accessible by the at least one second processor, and configured to cause the at least one second processor to: receive the central server system data; and autonomously control the second propulsion system to land the second manned VTOL aerial vehicle within a landing zone that is associated with the landing position vector.

In some embodiments, there is provided a manned VTOL aerial vehicle. The manned VTOL aerial vehicle may comprise: a body comprising a cockpit; a propulsion system carried by the body to propel the body during flight; pilot-operable controls accessible from the cockpit; a sensing system configured to generate sensor data associated with the manned VTOL aerial vehicle; and a control system comprising: at least one processor; and memory accessible by the at least one processor, the memory being configured to store: the sensor data; and a three-dimensional model associated with a region around the manned VTOL aerial vehicle; the memory storing program instructions accessible by the at least one processor, and configured to cause the at least one processor to: determine a position estimate that is indicative of a position of the manned VTOL aerial vehicle within the three-dimensional model; determine that the position estimate is outside a software-defined virtual region of the three-dimensional model; determine a restricted control vector based at least in part on: the determination that the position estimate is outside of the software-defined virtual region; and a control vector indicative of an input received via the pilot-operable controls; and control the propulsion system, based at least in part on the restricted control vector.

In some embodiments, the program instructions are configured to cause the at least one processor to determine the position estimate based at least in part on the sensor data.

In some embodiments, the sensing system comprises a Global Navigation Satellite System (GNSS) module configured to generate GNSS data that is indicative of a latitude and a longitude of the manned VTOL aerial vehicle; and the sensor data comprises the GNSS data.

In some embodiments, the sensing system comprises one or more of: an altimeter configured to provide, to the at least one processor, altitude data that is indicative of an altitude of the manned VTOL aerial vehicle; an accelerometer configured to provide, to the at least one processor, accelerometer data that is indicative of an acceleration of the manned VTOL aerial vehicle; a gyroscope configured to provide, to the at least one processor, gyroscopic data that is indicative of an orientation of the manned VTOL aerial vehicle; and a magnetometer sensor configured to provide, to the at least one processor, magnetic field data that is indicative of an azimuth orientation of the manned VTOL aerial vehicle; and wherein the sensor data comprises one or more of the altitude data, the acceleration data, the gyroscopic data and the magnetic field data.

In some embodiments, the sensing system comprises an imaging module configured to provide, to the at least one processor, image data that is associated with the region; and the sensor data comprises the image data.

In some embodiments, the imaging module comprises one or more of: a light detection and ranging (LIDAR) system configured to generate LIDAR data; a visible spectrum imaging module configured to generate visible spectrum image data; and a radio detecting and ranging (RADAR) system configured to generate RADAR data; and wherein the image data comprises one or more of the LIDAR data, the visible image data and the RADAR data.

In some embodiments, determining the position estimate comprises visual odometry.

In some embodiments, the control vector comprises a pitch element that is associated with a pitch angle of the manned VTOL aerial vehicle.

In some embodiments, determining the restricted control vector comprises reducing a maximum allowable magnitude of the pitch element.

In some embodiments, the restricted control vector is determined such that one or more of a velocity, acceleration, pitch, yaw and roll of the manned VTOL aerial vehicle is restricted.

In some embodiments, the program instructions are further configured to cause the at least one processor to: determine a user interface output to indicate a restricted control condition; and output the user interface output using a user interface of the manned VTOL aerial vehicle.

In some embodiments, the program instructions are further configured to cause the at least one processor to: determine restriction data that is associated with the restricted control vector; and transmit the restriction data using a communication system of the manned VTOL aerial vehicle to a server system or another vehicle.

In some embodiments, there is provided a system. The system may comprise: the manned VTOL aerial vehicle; and an autonomous vehicle comprising: an autonomous vehicle propulsion system; at least one autonomous vehicle processor; and autonomous vehicle memory storing autonomous vehicle program instructions accessible by the at least one autonomous vehicle processor, and configured to cause the at least one autonomous vehicle processor to: receive the restriction data; and control the autonomous vehicle propulsion system, based at least in part on the restriction data.

In some embodiments, there is provided a central server system. The central server system may comprise: a central server system communication network; at least one central server system processor; and central server system memory storing: a three-dimensional model of a region; and central server system program instructions accessible by the at least one central server system processor, and configured to cause the at least one central server system processor to: determine a position estimate that is indicative of a position of a manned VTOL aerial vehicle within the three-dimensional model; determine that the position estimate is outside a software-defined virtual region of the three-dimensional model; determine restriction condition data based at least in part on the determination that the position estimate is outside of the software-defined virtual region; and transmit the restriction condition data using the central server system communication network.

In some embodiments, the restriction condition data comprises user interface output data that is associated with the restriction condition; and the central server system program instructions are further configured to cause the at least one central server system processor to transmit the user interface output data using the central server system communication system to a server system or another vehicle.

In some embodiments, there is provided a system. The system may comprise: the central server system; and a manned VTOL aerial vehicle comprising: a body comprising a cockpit; a propulsion system carried by the body to propel the body during flight; pilot-operable controls accessible from the cockpit; a sensing system configured to generate sensor data associated with the manned VTOL aerial vehicle; a vehicle communication system; and a control system comprising: at least one processor; and memory storing program instructions accessible by the at least one processor, and configured to cause the at least one processor to transmit vehicle data using the vehicle communication system, the vehicle data comprising the sensor data.

In some embodiments, the program instructions are further configured to cause the at least one processor to: receive the restriction condition data using the vehicle communication system; determine a restricted control vector based at least in part on the restriction condition and a control vector indicative of an input received via the pilot-operable controls; and control the propulsion system, based at least in part on the restricted control vector.

In some embodiments, the central server system program instructions are configured to cause the at least one central server system processor to determine the position estimate based at least in part on the sensor data.

In some embodiments, the sensing system comprises a Global Navigation Satellite System (GNSS) module configured to generate GNSS data that is indicative of a latitude and a longitude of the manned VTOL aerial vehicle; and the sensor data comprises the GNSS data.

In some embodiments, the sensing system comprises one or more of: an altimeter configured to provide, to the at least one processor, altitude data that is indicative of an altitude of the manned VTOL aerial vehicle; an accelerometer configured to provide, to the at least one processor, accelerometer data that is indicative of an acceleration of the manned VTOL aerial vehicle; a gyroscope configured to provide, to the at least one processor, gyroscopic data that is indicative of an orientation of the manned VTOL aerial vehicle; and a magnetometer sensor configured to provide, to the at least one processor, magnetic field data that is indicative of an azimuth orientation of the manned VTOL aerial vehicle; and wherein the sensor data comprises one or more of the altitude data, the acceleration data, the gyroscopic data and the magnetic field data.

In some embodiments, the sensing system comprises an imaging module configured to provide, to the at least one processor, image data that is associated with the region; and the sensor data comprises the image data.

In some embodiments, the imaging module comprises one or more of: a light detection and ranging (LIDAR) system configured to generate LIDAR data; a visible spectrum imaging module configured to generate visible spectrum image data; and a radio detecting and ranging (RADAR) system configured to generate RADAR data; and wherein the image data comprises one or more of the LIDAR data, the visible image data and the RADAR data.

In some embodiments, determining the position estimate comprises visual odometry.

In some embodiments, the control vector comprises a pitch element that is associated with a pitch angle of the manned VTOL aerial vehicle.

In some embodiments, determining the restricted control vector comprises reducing a maximum allowable magnitude of the pitch element.

In some embodiments, the restricted control vector is determined such that one or more of a velocity, acceleration, pitch, yaw and a roll of the manned VTOL aerial vehicle is restricted.

In some embodiments, the program instructions are further configured to cause the at least one processor to: determine a user interface output to indicate a restricted control condition; and output the user interface output using a user interface of the manned VTOL aerial vehicle.

In some embodiments, there is provided a system. The system may comprise: the manned VTOL aerial vehicle; and an autonomous vehicle comprising: an autonomous vehicle propulsion system; at least one autonomous vehicle processor; and autonomous vehicle memory storing autonomous vehicle program instructions accessible by the at least one autonomous vehicle processor, and configured to cause the at least one autonomous vehicle processor to: receive the restriction condition data; and control the autonomous vehicle propulsion system, based at least in part on the restriction condition data.

### BRIEF DESCRIPTION OF DRAWINGS

Embodiments of the present disclosure will now be described by way of non-limiting example only with reference to the accompanying drawings, in which:

FIG. 1 illustrates a front perspective view of a manned VTOL aerial vehicle, according to some embodiments;

FIG. 2 illustrates a rear perspective view of the manned VTOL aerial vehicle, according to some embodiments;

FIG. 3 is a block diagram of an aerial vehicle system, according to some embodiments;

FIG. 3A is a block diagram of the aerial vehicle system of FIG. 3, when in the context of a manned VTOL aerial vehicle race track;

FIG. 4 is a block diagram of a control system of the manned VTOL aerial vehicle, according to some embodiments;

FIG. 5 is a block diagram of an alternative control system or the manned VTOL aerial vehicle, according to some embodiments;

FIG. 6 is a block diagram of a sensing system of the manned VTOL aerial vehicle, according to some embodiments;

FIG. 7 is a block diagram of an external sensing system, according to some embodiments;

FIG. 8 illustrates a front perspective view of a manned VTOL aerial vehicle, showing example positions of a plurality of sensors of a sensing system, according to some embodiments;

FIG. 9 is a process flow diagram of a computer-implemented method for determining an authorisation status of a manned VTOL aerial vehicle, according to some embodiments;

FIG. 10 is a process flow diagram of a computer-implemented method for autonomously controlling a manned VTOL aerial vehicle, according to some embodiments;

FIG. 11 is a process flow diagram of a computer-implemented method for transmitting central server system data, according to some embodiments;

FIG. 12 is a process flow diagram of a computer-implemented method for controlling a manned VTOL aerial vehicle, according to some embodiments;

FIG. 13 is a process flow diagram of a computer-implemented method for transmitting restriction condition data, according to some embodiments; and

FIG. 14 is a block diagram of a propulsion system, according to some embodiments.

### DESCRIPTION OF EMBODIMENTS

Manned vertical take-off and landing (VTOL) aerial vehicles are used in a number of applications. These aerial vehicles can travel through a region of airspace. For example, competitive manned VTOL aerial vehicle racing can involve a plurality of manned VTOL aerial vehicles navigating a track (a region of airspace), each with a goal of navigating the track in the shortest amount of time. The track may have a complex shape, may cover a large area and/or may include a number of obstacles around which the manned VTOL aerial vehicles must navigate (including other vehicles, for example).

More generally, the region of airspace may be associated with an entity (e.g. the company facilitating the competitive manned VTOL aerial vehicle racing) which may restrict access to the region or access to information relating to the region only to authorised vehicles associated with the entity. In some cases, the region may be near a government or company facility and access to the region or access to information relating to the region may be restricted to authorised aerial vehicles that are associated with that facility.

Certain aspects of the region may change with time. For example, the position of one or more physical objects within the region may change with time. A three-dimensional model of the region and a state of these objects can be determined, for example, by a ground-based computer system. The three-dimensional model of the region can be provided to vehicles that are authorised to travel through the region to assist with their navigation of the region.

Furthermore, one or more virtual objects may be associated with the region. For example, the boundaries of the three-dimensional race track may be defined by virtual walls. The three-dimensional model of the region can include these virtual objects.

Aerial vehicles can suffer from equipment failures, for example, a propulsion system failure, or can collide with objects such as birds, walls, buildings or other aerial vehicles during flight. Equipment failures and collisions can be dangerous to both the pilot and people or objects nearby that can be hit by debris or the aerial vehicle itself. This can be a particularly large issue for high density airspace.

Aerial vehicles can include a sensing system that monitors on-board equipment to detect an equipment failure caused by, for example, a manufacturing defect or a collision. In the event that an equipment failure is detected, remedial action can be taken by the pilot and/or the aerial vehicle to improve the likelihood that the aerial vehicle lands safely and with minimal damage. Similarly, the aerial vehicle may be capable of communicating with a ground-based computer system. The aerial vehicle may transmit data generated by the sensing system to the ground-based computer system, which may process the data and remotely control the aerial vehicle, generate instructions for the pilot based at least in part on the processed data, or perform either of these actions for other vehicles.

The ground-based computer system may provide relevant data to other vehicles in the region. For example, where it is determined that a first vehicle has experienced an equipment failure, the ground-based computer system can communicate with other vehicles in the region to instruct them to avoid the first vehicle to reduce the risk of a collision.

Aerial vehicles operating within the region may be subject to one or more operating conditions. For example, the aerial vehicles may be restricted to flying within only certain allowed areas of the region. If the aerial vehicles operate outside the operating conditions, for example, by travelling outside the allowed areas of the region, the operation of the aerial vehicle may be restricted in response. For example, a maximum velocity of the aerial vehicle may be restricted, either by an on-board control system or a ground-based control system that communicates with the aerial vehicle.

### Manned Vertical Take-Off and Landing Aerial Vehicle

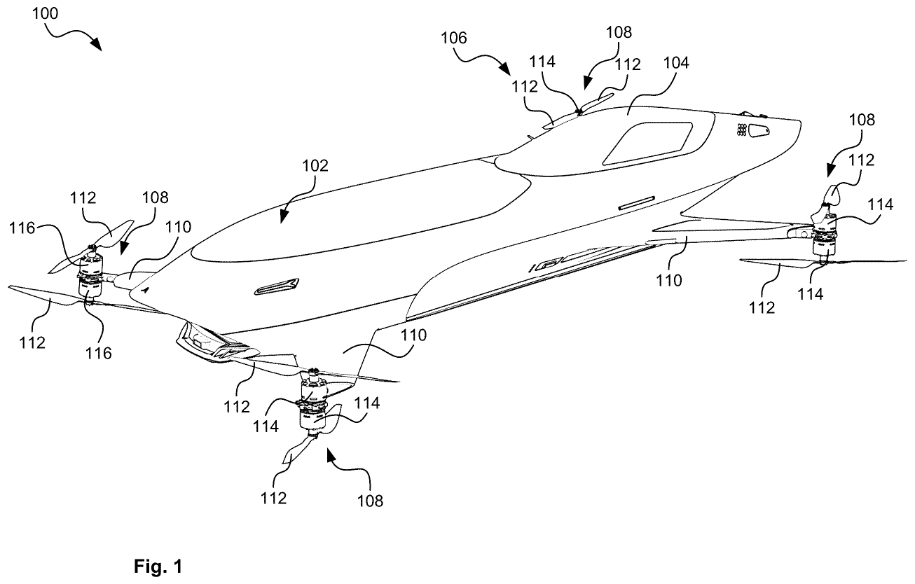

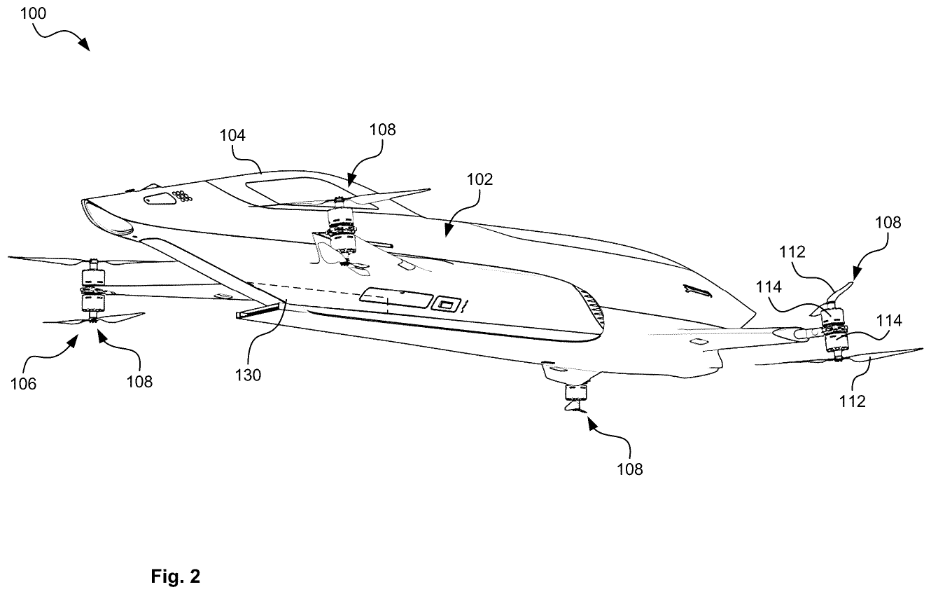

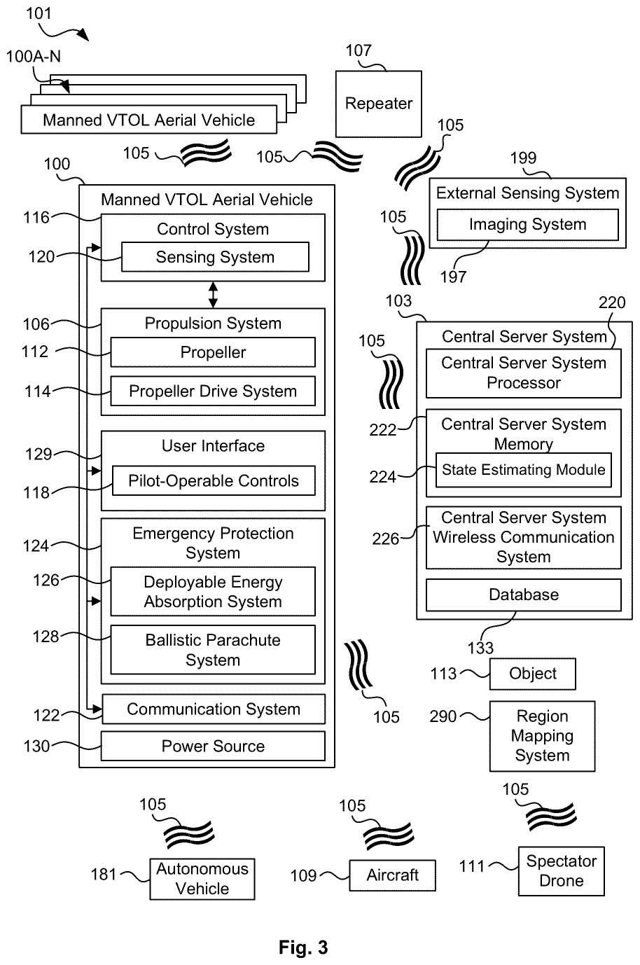

FIG. 1 illustrates a front perspective view of a manned vertical take-off and landing (VTOL) aerial vehicle 100. FIG. 2 illustrates a rear perspective view of the manned VTOL aerial vehicle 100. The manned VTOL aerial vehicle 100 is configured to move within a region. Specifically, the manned VTOL aerial vehicle 100 is configured to fly within a region that comprises an object 113 (shown in FIG. 3). In some embodiments, the manned VTOL aerial vehicle 100 may be referred to as a speeder.

The manned VTOL aerial vehicle 100 is a rotary wing vehicle. The manned VTOL aerial vehicle 100 can move omnidirectionally in a three-dimensional space. In some embodiments, the manned VTOL aerial vehicle 100 has a constant deceleration limit. In some embodiments, the manned VTOL aerial vehicle 100 is in the form of an electric vertical take-off and landing aerial vehicle (eVTOL). In such embodiments, the manned VTOL aerial vehicle 100 includes one rechargeable electric battery or multiple rechargeable electric batteries to supply power for operation of the various powered components of the manned VTOL aerial vehicle 100.

The manned VTOL aerial vehicle 100 comprises a body 102. The body 102 may comprise a fuselage. The body 102 comprises a cockpit 104 sized and configured to accommodate a human pilot. The cockpit 104 comprises a user interface 129. The user interface comprises a display (not shown). The display is configured to display information to the pilot. The display may be implemented as a heads-up display, an electroluminescent (ELD) display, light-emitting diode (LED) display, quantum dot (QLED) display, organic light-emitting diode (OLED) display, liquid crystal display, a plasma screen, as a cathode ray screen device or the like.

In some embodiments, the body 102 comprises, or is in the form of a monocoque. For example, the body 102 may comprise or be in the form of a carbon fibre monocoque. The manned VTOL aerial vehicle 100 comprises pilot-operable controls 118 (FIG. 3) that are accessible from the cockpit 104. In some embodiments, the user interface 129 comprises the pilot-operable controls 118. The manned VTOL aerial vehicle 100 comprises a propulsion system 106. The propulsion system 106 is carried by the body 102 to propel the body 102 during flight.

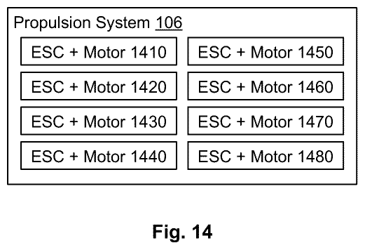

The propulsion system 106 comprises a propeller system 108. The propeller system 108 comprises a plurality of propellers 112 and a plurality of propeller drive systems 114. That is, the propeller system 108 comprises multiple propellers 112 and a propeller drive system 114 for each propeller 112. The propeller drive system 114 comprises a propeller motor. In particular, the propeller drive system 114 may comprise a brushless motor. The propeller motor may be controlled via an electronic speed control (ESC) circuit for each propeller 112 of the propeller system 108, as illustrated in FIG. 14.

FIG. 14 is a block diagram of propulsion system 106 according to some embodiments. Propulsion system 106 may comprise a plurality of electronic speed controller (ESC) and motor pairs 1410, 1420, 1430, 1440, 1450, 1460, 1470, and 1480. The eight ESC and motor pairs are used to control pairs of propellers 112. That is, two ESC and motor pairs are used in conjunction with one another for a total of four propeller systems 108, for example. Propulsion system 106 is carried by the body 102 to propel the body 102 during flight.

The propulsion system 106 of the manned VTOL aerial vehicle 100 illustrated in FIG. 1 and FIG. 2 comprises a plurality of propeller systems 108. In particular, the propulsion system 106 of the manned VTOL aerial vehicle 100 illustrated in FIG. 1 and FIG. 2 comprises four propeller systems 108. Each propeller system 108 comprises a first propeller and a first propeller drive system. Each propeller system 108 also comprises a second propeller and a second propeller drive system. The first propeller drive system is configured to selectively rotate the first propeller in a first direction of rotation or a second direction opposite the first direction. The second propeller drive system is configured to selectively rotate the second propeller in the first direction of rotation or the second direction.

Each propeller system 108 is connected to a respective elongate body portion 110 of the body 102. The elongate body portions 110 may be referred to as “arms” of the body 102. Each propeller system 108 is mounted to the body 102 such that the propeller systems 108 form a generally quadrilateral profile.

By selective control of the propeller systems 108, the manned VTOL aerial vehicle 100 can be accurately controlled to move within three-dimensional space. The manned VTOL aerial vehicle 100 is capable of vertical take-off and landing.

As described herein, the manned VTOL aerial vehicle 100 may be propelled through a region. The region is a region of three-dimensional space. A three-dimensional region coordinate system may be overlayed onto the region. The three-dimensional region coordinate system comprises a region origin. A position of each point of the region can be represented by a region position vector. The region position vector of a respective point of the region may comprise a plurality of region position vector elements that uniquely identify that respective point with respect to the region origin and a plurality of region basis vectors. The plurality of region basis vectors form a basis of the three-dimensional region coordinate system. Each of the plurality of region basis vectors may be a unit vector. Each of the region basis vectors defines a respective dimensional axis of the region. The region position vector of a respective point may comprise region position vector elements that correspond to a magnitude of each of the region basis vectors that span from the model origin to the respective point of the region.

As is also described herein, a three-dimensional model of the region may be determined. The three-dimensional model of the region may be determined using sensor data provided by one or more sensing systems. A three-dimensional model coordinate system may be overlayed onto the three-dimensional model of the region. The three-dimensional model coordinate system comprises a model origin. A position of each point of the three-dimensional model of the region can be represented by a model position vector. The model position vector of a respective point of the three-dimensional model may comprise a plurality of model position vector elements that uniquely identify that respective point with respect to the model origin and a plurality of model basis vectors of the three-dimensional model coordinate system. The plurality of model basis vectors form a basis of the three-dimensional model. Each of the plurality of model basis vectors may be a unit vector. Each of the model basis vectors defines a respective dimensional axis of the three-dimensional model. The model position vector of a respective point may comprise elements that correspond to a magnitude of each of the basis vectors that span from the model origin to the respective point of the three-dimensional model.

In some embodiments, the region origin corresponds to the model origin. That is, the point corresponding to the region origin is the same as the point corresponding to the model origin. In some embodiments, each of the region basis vectors corresponds to a respective one of the model basis vectors. In this way, a region position vector may directly correspond to a model position vector. That is, the point represented by a region position vector may correspond to the point represented by a model position vector with common element values.

In some embodiments, one or more of the model origin and model basis vectors differ from the region origin or a respective region basis vector. In these embodiments, a first transformation operator can be used to convert a model position vector to a region position vector associated with a common point of the region. The first transformation operator may be a transformation matrix. Similarly, a second transformation operator can be used to convert a region position vector to a model position vector associated with a common point of the region. The second transformation operator may be a transformation matrix.

As described herein, the region may comprise an object 113. The object 113 may be a static object. That is, the object 113 may be static with respect to the region (e.g. the region origin or the three-dimensional region coordinate system). Further, the object 113 may be static with respect to a fixed reference frame of the three-dimensional model of the region (e.g. the model origin or the three-dimensional model coordinate system). The object 113 may be a dynamic object. That is, the object 113 may be dynamic (or move) with respect to the region (e.g. the region origin or the three-dimensional region coordinate system) over time. Alternatively, the object 113 may be dynamic with respect to a fixed reference frame of the three-dimensional model of the region (e.g. the model origin or the three-dimensional model coordinate system).

The object 113 may be a real object. That is, the object 113 may exist within the three-dimensional space of the region. For example, the object 113 may define a surface (such as the ground, a wall, a ceiling etc.) or an obstacle (such as another vehicle, a track marker, a tree or a bird). Alternatively, the object 113 may be a virtual object. For example, the object 113 may be defined only in the three-dimensional model of the region. For example, the object 113 may be a virtual surface (such as a virtual wall, a virtual ceiling etc.), a virtual obstacle (such as a virtual vehicle, a virtual track marker, a virtual tree or a virtual bird) or a virtual boundary within which it is desired to maintain the manned VTOL aerial vehicle 100.

Virtual objects can be useful for artificially constraining the region within which the manned VTOL aerial vehicle can fly. For example, the virtual object can be in the form of a three-dimensional virtual boundary. The manned VTOL aerial vehicle 100 may be authorised to fly within the three-dimensional virtual boundary (e.g. a race track), and unauthorised to fly outside the three-dimensional virtual boundary. The three-dimensional virtual boundary can form a complex three-dimensional flight path, allowing simulation of a technically challenging flight path. Thus, the virtual objects can be used for geofencing. Virtual objects can also be used for pilot training. For example, when the pilot trains to race the manned VTOL aerial vehicle 100, other vehicles against which the pilot can race can be simulated using virtual objects. This reduces the need to actually have other vehicles present, and improves the safety of the pilot, as the risk of the pilot crashing is reduced.

In some embodiments, the region comprises a plurality of objects 113. A first sub-set of the plurality of objects 113 may be dynamic objects. A second sub-set of the plurality of objects may be static objects.

### Aerial Vehicle System

FIG. 3 is a block diagram of an aerial vehicle system 101, according to some embodiments. The aerial vehicle system 101 comprises the manned VTOL aerial vehicle 100. As previously described, the manned VTOL aerial vehicle 100 comprises a propulsion system 106 that comprises a plurality of propellers 112 and propeller drive systems 114. The manned VTOL aerial vehicle 100 comprises a control system 116. The control system 116 is configured to enable control of the manned VTOL aerial vehicle 100. In particular, the control system 116 may be configured to enable control of the manned VTOL aerial vehicle 100 to be shared between a pilot and an autonomous piloting system. The control system 116 is configured to communicate with the propulsion system 106. In particular, the control system 116 is configured to control the propulsion system 106 so that the propulsion system 106 can selectively propel the body 102 during flight.

The manned VTOL aerial vehicle 100 comprises a sensing system 120. In particular, the control system 116 comprises the sensing system 120. The sensing system 120 is configured to generate sensor data. The control system 116 is configured to process the sensor data to control the manned VTOL aerial vehicle 100 and/or provide outputs to the pilot.

The manned VTOL aerial vehicle 100 comprises the user interface 129. The user interface 129 comprises pilot-operable controls 118. A pilot can use the pilot-operable controls 118 to control the manned VTOL aerial vehicle 100 in flight. The pilot-operable controls 118 are configured to communicate with the control system 116. In particular, the control system 116 processes input data generated by actuation of the pilot-operable controls 118 by the pilot to control the manned VTOL aerial vehicle 100. The input data may be in the form of a control vector. In particular, the input data may be in the form of a time series of control vectors. In other words, a control vector is indicative of an input received via the pilot-operable controls 118. The control vector comprises a thrust element that is associated with an angular velocity of a respective propeller 112 of the propulsion system 106. In particular, a value of the thrust element is related to the angular velocity of the respective propeller 112. Thus, the control vector comprises a plurality of thrust elements. In some embodiments, the control vector comprises first, second, third, fourth, fifth, sixth, seventh and eighth thrust elements (i.e. one thrust element for each propeller 112 of the propulsion system 106). The control vector comprises a pitch element that is associated with a pitch of the manned VTOL aerial vehicle 100. In particular, a value of the pitch element is related to a maximum pitch angle at which the manned VTOL aerial vehicle 100 is enabled to manoeuvre.

The control system 116 is configured to process the input data generated by the actuation of the pilot-operable controls 118 (i.e. the control vector). The control vector may be referred to as an input vector. The input data may be indicative of an intended control velocity of the manned VTOL aerial vehicle 100, as is described in more detail herein.

The manned VTOL aerial vehicle 100 comprises a communication system 122. The communication system 122 may be a wireless communication system. The communication system 122 is configured to communicate with the control system 116. The manned VTOL aerial vehicle 100 is configured to communicate with other computing devices using the communication system 122. The communication system 122 may comprise a vehicle network interface 155. The vehicle network interface 155 is configured to enable the manned VTOL aerial vehicle 100 to communicate with other computing devices using one or more communication networks. The manned VTOL aerial vehicle 100 is configured to communicate with other computing devices using the communication system 122 and a communication network 105, as is described in more detail herein. The manned VTOL aerial vehicle 100 is configured to transmit vehicle data using the communication system 122.

The vehicle network interface 155 may comprise a combination of network interface hardware and network interface software suitable for establishing, maintaining and facilitating communication over a relevant communication channel. Examples of a suitable communication network include a cloud server network, a wired or wireless internet connection, a wireless local area network (WLAN) such as Wi-Fi (IEEE 82.15.1) or Zigbee (IEE 802.15.4), a wireless wide area network (WWAN) such as cellular 4G LTE and 5G or another cellular network connection, dedicated short-range communications (DSRC) (e.g. IEEE 802.11p), low power wide area networks (LPWAN) such as SigFox and Lora, Bluetooth™ or other near field radio communication, and/or physical media such as a Universal Serial Bus (USB) connection.

The manned VTOL aerial vehicle 100 also comprises an internal communication network (not shown). The internal communication network is a wired network. The internal communication network connects the at least one processor 132, memory 134 and other components of the manned VTOL aerial vehicle 100 such as the propulsion system 106. The internal communication network may comprise a serial link, Ethernet network, a controlled area network (CAN) or another network.

The manned VTOL aerial vehicle 100 comprises an emergency protection system 124. The emergency protection system 124 is in communication with the control system 116. The emergency protection system 124 is configured to protect the pilot and/or the manned VTOL aerial vehicle 100 in a case where the manned VTOL aerial vehicle 100 is in a collision. That is, the control system 116 may deploy one or more aspects of the emergency protection system 124 to protect the pilot and/or the manned VTOL aerial vehicle 100.

The emergency protection system 124 comprises a deployable energy absorption system 126. In some embodiments, the deployable energy absorption system 126 comprises an airbag. The deployable energy absorption system 126 is configured to deploy in the case where the manned VTOL aerial vehicle 100 is in a collision. The deployable energy absorption system 126 may deploy if an acceleration of the manned VTOL aerial vehicle 100 exceeds an acceleration threshold. For example, the deployable energy absorption system 126 may deploy if the control system 116 senses or determines a deceleration magnitude of the manned VTOL aerial vehicle 100 that is indicative of a magnitude of a deceleration of the manned VTOL aerial vehicle 100 being greater than a predetermined deceleration magnitude threshold.

The emergency protection system 124 comprises a ballistic parachute system 128. The ballistic parachute system 128 is configured to deploy to protect the pilot and/or the manned VTOL aerial vehicle 100 in a number of conditions. These may include the case where the manned VTOL aerial vehicle 100 is in a collision, or where the propulsion system 106 malfunctions. For example, if one or more of the propeller drive systems 114 fail and the manned VTOL aerial vehicle 100 is unable to be landed safely, the ballistic parachute system 128 may deploy to slow the descent of the manned VTOL aerial vehicle 100. In some cases, the ballistic parachute system 128 is configured to deploy if two propeller drive systems 114 on one elongate body portion 110 fail.

The manned VTOL aerial vehicle 100 comprises a power source 130. The power source 130 may comprise one or more batteries. For example, the manned VTOL aerial vehicle 100 may comprise one or more batteries that are stored in a lower portion of the body 102. For example, as shown in FIG. 2, the batteries may be stored below the cockpit 104. The power source 130 is configured to power each sub-system of the manned VTOL aerial vehicle 100 (e.g. the control system 116, propulsion system 106 etc.). The manned VTOL aerial vehicle 100 comprises a battery management system. The battery management system is configured to estimate a charge state of the one or more batteries. The battery management system is configured to perform battery balancing. The battery management system is configured to monitor the health of the one or more batteries. The battery management system is configured to monitor a temperature of the one or more batteries. The battery management system is configured to monitor a tension of the one or more batteries. The battery management system is configured to isolate a battery of the one or more batteries from a load, if required. The battery management system is configured to saturate an input power of the one or more batteries. The battery management system is configured to saturate an output power of the one or more batteries.

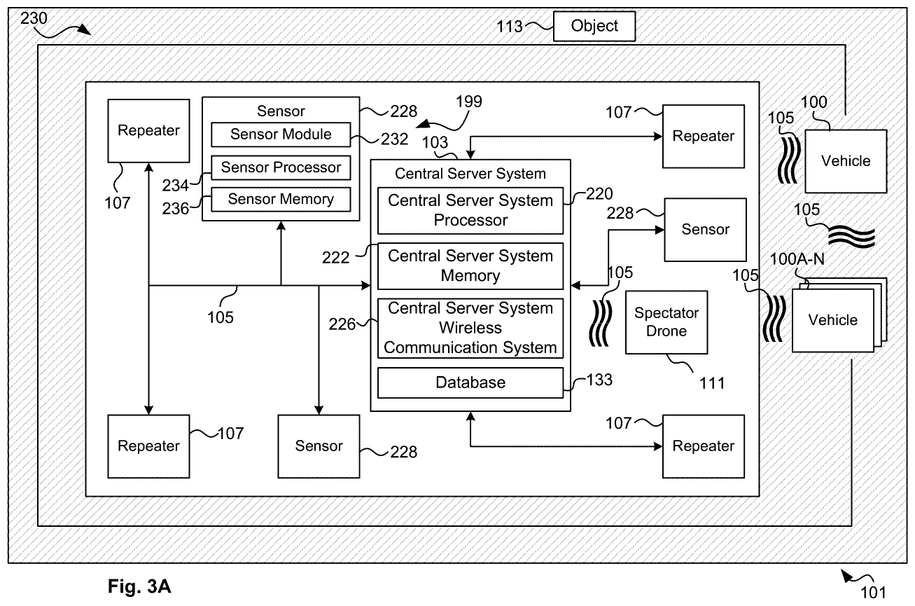

FIG. 4 is a block diagram of the control system 116, according to some embodiments. The control system 116 comprises at least one processor 132. The at least one processor 132 is configured to be in communication with memory 134. As previously described, the control system 116 comprises the sensing system 120. The sensing system 120 is configured to communicate with the at least one processor 132. In some embodiments, the sensing system 120 is configured to provide the sensor data to the at least one processor 132. In some embodiments, the at least one processor 132 is configured to receive the sensor data from the sensing system 120. In some embodiments, the at least one processor 132 is configured to retrieve the sensor data from the sensing system 120. The at least one processor 132 is configured to store the sensor data in the memory 134. In some embodiments, the vehicle data comprises the sensor data.

The at least one processor 132 is configured to execute program instructions stored in memory 134 to cause the control system 116 to function as described herein. In particular, the at least one processor 132 is configured to execute the program instructions to cause the manned VTOL aerial vehicle 100 to function as described herein. In other words, the program instructions are accessible by the at least one processor 132, and are configured to cause the at least one processor 132 to function as described herein. In some embodiments, the program instructions may be referred to as control system program instructions.

In some embodiments, the program instructions are in the form of program code. The at least one processor 132 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The program instructions comprise one or more of a region mapping module 159, a state estimating module 139, a collision avoidance module 140, a cockpit warning module 161 and a control module 141. The at least one processor 132 determines a state of the manned VTOL aerial vehicle 100 by executing the state estimating module 139. The at least one processor 132 may determine a three-dimensional model of at least part of the region by executing the region mapping module 159. The at least one processor 132 may optimise a flight path of the manned VTOL aerial vehicle 100 to avoid one or more obstacles (e.g. the object 113) by executing the collision avoidance module 140. The at least one processor 132 may control the propulsion system 106 by executing the control module 141. The at least one processor 132 may provide a warning in the cockpit 104 by executing the cockpit warning module 161. For example, the at least one processor 132 may output the user interface output described herein by executing the cockpit warning module 161.

Memory 134 may comprise one or more volatile or non-volatile memory types. For example, memory 134 may comprise one or more of random access memory (RAM), read-only memory (ROM), electrically erasable programmable read-only memory (EEPROM) or flash memory. Memory 134 is configured to store program code accessible by the at least one processor 132. The program code may comprise executable program code modules. In other words, memory 134 is configured to store executable code modules configured to be executable by the at least one processor 132. The executable code modules, when executed by the at least one processor 132 cause the at least one processor 132 to perform certain functionality, as described herein. In the illustrated embodiment, the region mapping module 159, the cockpit warning module 161, the state estimating module 139, the collision avoidance module 140 and the control module 141 are in the form of program code stored in the memory 134.

The state estimating module 139, the region mapping module 159, the cockpit warning module 161, the collision avoidance module 140 and/or the control module 141 are to be understood to be one or more software programs. They may, for example, be represented by one or more functions in a programming language, such as C++, C, C#, Python or Java. The resulting source code may compiled and stored as computer executable instructions on memory 134 that are in the form of the relevant executable code module.

Memory 134 is also configured to store a three-dimensional model. The three-dimensional model may be a three-dimensional model of the region (the track, or a sub-section of the track) as described herein. That is, the three-dimensional model may represent the region. The three-dimensional model may have an orientation that corresponds with that of the region as described herein, and surfaces of the three-dimensional model may correspond to surfaces of the region. The three-dimensional model may be the three-dimensional model of the region generated by a region mapping system 290, as is described in more detail herein. Positions and/or directions within the three-dimensional model are indicated with respect to a three-dimensional model coordinate system, as described herein.

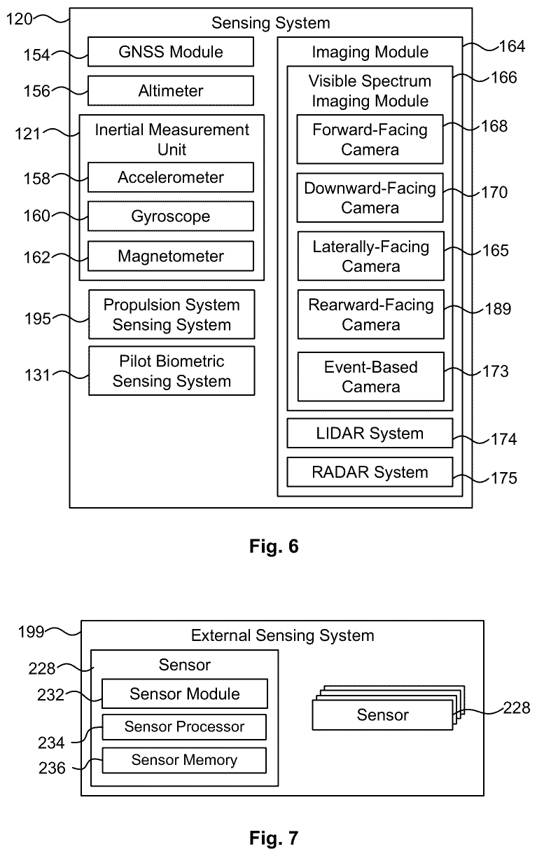

FIG. 6 is a block diagram of the sensing system 120, according to some embodiments. The sensing system 120 comprises a Global Navigation Satellite System (GNSS) module 154. The GNSS module 154 comprises a GNSS antenna that is configured to receive a signal from a satellite of a GNSS constellation. The GNSS module 154 may comprise or be in the form of a GNSS real time kinetics (RTK) sensor. The GNSS module 154 may be configured to receive a Differential GNSS RTK correction signal from a fixed reference ground station. The reference ground station may be a GNSS reference ground station. This may be, for example, via the communication network 105, or another communication network.

The GNSS module 154 is configured to generate GNSS data. The GNSS data is indicative of one or more of a latitude, a longitude and an altitude of the manned VTOL aerial vehicle 100. The GNSS data may be in the form of a GNSS data vector that is indicative of the latitude, longitude and/or altitude of the manned VTOL aerial vehicle 100 at a particular point in time. Alternatively, the GNSS data may comprise GNSS time-series data. The GNSS time-series data can be indicative of the latitude, longitude and/or altitude of the manned VTOL aerial vehicle 100 over a time window. The GNSS time-series data can include GNSS data vectors that are sampled at a particular GNSS time frequency. The GNSS data may include a GNSS uncertainty metric that is indicative of an uncertainty of the relevant GNSS data.

The GNSS module 154 may be configured to utilise a plurality of GNSS constellations. For example, the GNSS module may be configured to utilise one or more of a Global Positioning System (GPS), a Global Navigation Satellite System (GLONASS), a BeiDou Navigation Satellite System (BDS), a Galileo system, a Quasi-Zenith Satellite System (QZSS) and an Indian Regional Navigation Satellite System (IRNSS or NavIC). In some embodiments, the GNSS module 154 is configured to utilise a plurality of GNSS frequencies simultaneously. In some embodiments, the GNSS module 154 is configured to utilise a plurality of GNSS constellations simultaneously.

The GNSS module 154 is configured to provide the GNSS data to the control system 116. In some embodiments, the GNSS module 154 is configured to provide the GNSS data to the at least one processor 132. The GNSS module 154 is configured to provide the GNSS data to the at least one processor 132. The sensor data comprises the GNSS data.

In some embodiments, the sensing system 120 comprises a plurality of GNSS modules 154. For example, the sensing system 120 may comprise two or more GNSS modules 154. Each of the additional GNSS modules 154 may be as described with reference to the GNSS module 154 described herein. The plurality of GNSS modules 154 may be positioned at different positions on the manned VTOL aerial vehicle 100. Thus, including two or more GNSS modules 154 enables the capability to estimate a heading of the manned VTOL aerial vehicle 100. A position estimate can be determined using GNSS data from each of the GNSS modules 154 and, as their position on the manned VTOL aerial vehicle 100 is known, the multiple position estimates can be used to determine the manned VTOL aerial vehicle's 100 heading.

The sensing system 120 comprises an altimeter 156. The altimeter 156 is configured to generate altitude data. The altitude data is indicative of an altitude of the manned VTOL aerial vehicle 100. The altimeter 156 may comprise a barometer. The barometer may be configured to determine an altitude estimate above a reference altitude. The reference altitude may be an altitude threshold. The altimeter 156 may comprise a radar altimeter 163. The radar altimeter 163 is configured to determine an estimate of an above-ground altitude. That is, the radar altimeter 163 is configured to determine an estimate of a distance between the manned VTOL aerial vehicle 100 and the ground. The altimeter 156 is configured to provide the altitude data to the control system 116. In some embodiments, the altimeter 156 is configured to provide the altitude data to the at least one processor 132. The sensor data comprises the altitude data.

The sensing system 120 comprises an inertial measurement unit 121. The inertial measurement unit 121 comprises an accelerometer 158. The accelerometer 158 is configured to generate accelerometer data. The accelerometer data is indicative of an acceleration of the manned VTOL aerial vehicle 100. The accelerometer data is indicative of acceleration in one or more of a first acceleration direction, a second acceleration direction and a third acceleration direction. The first acceleration direction, second acceleration direction and third acceleration direction may be orthogonal with respect to each other. The accelerometer 158 is configured to provide the accelerometer data to the control system 116. In some embodiments, the accelerometer 158 is configured to provide the accelerometer data to the at least one processor 132. The sensor data comprises the accelerometer data.

The inertial measurement unit 121 comprises a gyroscope 160. The gyroscope 160 is configured to generate gyroscopic data. The gyroscopic data is indicative of an orientation of the manned VTOL aerial vehicle 100. The gyroscope 160 is configured to provide the gyroscopic data to the control system 116. In some embodiments, the gyroscope 160 is configured to provide the gyroscopic data to the at least one processor 132. The sensor data comprises the gyroscopic data.

The inertial measurement unit 121 comprises a magnetometer sensor 162. The magnetometer sensor 162 is configured to generate magnetic field data. The magnetic field data is indicative of an azimuth orientation of the manned VTOL aerial vehicle 100. The magnetometer sensor 162 is configured to provide the magnetic field data to the control system 116. In some embodiments, the magnetometer sensor 162 is configured to provide the magnetic field data to the at least one processor 132. The sensor data comprises the magnetic field data.

In some embodiments, the sensing system 120 comprises a plurality of inertial measurement units 121. As a result, the sensing system 120 may comprise a plurality of accelerometers 158, gyroscopes 160 and magnetometer sensors 162. In some embodiments, the sensing system 120 comprises three inertial measurement units 121. In some embodiments, the sensing system 120 comprises two magnetometer sensors 162.

The sensing system 120 comprises a propulsion system sensing system 195. The propulsion system sensing system 195 is configured to generate propulsion system data that is associated with the propulsion system 106. The propulsion system sensing system 195 comprises a propulsion system temperature sensor (not shown). The propulsion system temperature sensor is configured to generate temperature data that is indicative of a temperature of one of the propeller drive systems 114, or a component of the relevant propeller drive system 114. The propulsion system sensing system 195 comprises a propulsion system vibration sensor (not shown). The propulsion system vibration sensor is configured to generate vibration data that is indicative of vibration of one of the propeller drive systems 114, or a component of the relevant propeller drive system 114. The propulsion system sensing system 195 comprises a propulsion system current sensor (not shown). The propulsion system current sensor is configured to generate current data that is indicative of an electrical current through one of the propeller drive systems 114, or a component of the relevant propeller drive system 114. The propulsion system sensing system 195 comprises a propulsion system voltage sensor (not shown). The propulsion system voltage sensor is configured to generate voltage data that is indicative of a voltage across one of the propeller drive systems 114, or a component of the relevant propeller drive system 114. The sensor data comprises the propulsion system data.

In some embodiments, the sensor data comprises diagnostic data. One or more of the types of sensor data described herein may be considered diagnostic data. For example, the current data generated by the propulsion system current sensor may be considered diagnostic data. In some cases, if the current data indicates that the current through one of the propeller drive systems 114, or a component of the relevant propeller drive system 114 is outside an expected operating range, such information can be considered diagnostic data indicative of a fault condition of the relevant propeller drive system 114. Similarly, if the current data indicates that the current through one of the propeller drive systems 114, or a component of the relevant propeller drive system 114 is within the expected range, such information can be considered diagnostic data indicative of a no-fault condition of the relevant propeller drive system 114.

The sensing system comprises a pilot biometric sensing system 131. The pilot biometric sensing system 131 is configured to generate pilot biometric data. The pilot biometric sensing system 131 may comprise a pilot heart rate sensor configured to measure the pilot's heart rate. The pilot biometric sensing system 131 may be configured to determine a pilot breath rate value indicative of a rate at which the pilot is breathing. The pilot biometric sensing system 131 may comprise a pilot biometric camera. The pilot biometric sensing system 131 may be configured to determine an alertness status of the pilot using image data generated by the pilot biometric data. For example, the pilot biometric sensing system 131 may track the pilot's eyes to determine the alertness status. The alertness status may take one of a number of values. For example, the alertness status may indicate that the pilot is conscious. Alternatively, the alertness status may indicate that the pilot is unconscious, for example, in cases where the pilot's eyes are closed for an extended period of time. The sensor data comprises the pilot biometric data.

The sensing system 120 comprises an imaging module 164. The imaging module 164 is configured to generate image data. In particular, the imaging module 164 is configured to generate image data that is associate with the region around the manned VTOL aerial vehicle 100. The imaging module 164 is configured to provide the image data to the control system 116. In some embodiments, the imaging module 164 is configured to provide the image data to the at least one processor 132. The sensor data comprises the image data.

The imaging module 164 comprises a visible spectrum imaging module 166. The visible spectrum imaging module 166 is configured to generate visible spectrum image data that is associated with the region around the manned VTOL aerial vehicle 100. The visible spectrum imaging module 166 is configured to provide the visible spectrum image data to the control system 116. In some embodiments, the visible spectrum imaging module 166 is configured to provide the visible spectrum image data to the at least one processor 132. The image data comprises the visible spectrum image data.

The visible spectrum imaging module 166 comprises a plurality of visible spectrum cameras 167. The visible spectrum cameras 167 are distributed across the body 102 of the manned VTOL aerial vehicle 100. The image data comprises visible spectrum image data. The image data comprises the optical flow data.

The visible spectrum imaging module 166 comprises a forward-facing camera 168. The forward-facing camera 168 is configured to generate image data that is associated with a portion of the region visible in front of a front portion 115 of the manned VTOL aerial vehicle 100. The forward-facing camera 168 is configured to be mounted to the manned VTOL aerial vehicle 100. In some embodiments, the visible spectrum imaging module 166 comprises a plurality of forward-facing cameras 168. Each forward-facing camera 168 may have different (but possibly overlapping) fields of view to capture images of different regions visible in front of the front portion 115 of the manned VTOL aerial vehicle 100.

The visible spectrum imaging module 166 also comprises a downward-facing camera 170. The downward-facing camera 170 is configured to generate image data that is associated with a portion of the region visible below the manned VTOL aerial vehicle 100. The downward-facing camera 170 is configured to be mounted to the manned VTOL aerial vehicle 100. In some embodiments, the visible spectrum imaging module 166 comprises a plurality of downward-facing cameras 170. Each downward-facing camera 170 may have different (but possibly overlapping) fields of view to capture images of different regions visible below the body 102 of the manned VTOL aerial vehicle 100. The downward-facing camera 170 may be referred to as a ground-facing camera. The downward-facing camera 170 may be referred to as a ground-facing camera.

The visible spectrum imaging module 166 comprises a laterally-facing camera 165. The laterally-facing camera 165 is configured to generate image data that is associated with a portion of the region visible to a side of the manned VTOL aerial vehicle 100. The laterally-facing camera 165 is configured to be mounted to the manned VTOL aerial vehicle 100. In some embodiments, the visible spectrum imaging module 116 may comprise a plurality of laterally-facing cameras 165. Each laterally-facing camera 165 may have different (but possibly overlapping) fields of view to capture images of different regions visible laterally of the body 102 of the manned VTOL aerial vehicle 100.

The visible spectrum imaging module 166 comprises a rearward-facing camera 189. The rearward-facing camera 189 is configured to generate image data that is associated with a portion of the region visible behind the manned VTOL aerial vehicle 100. The rearward-facing camera 189 is configured to be mounted to the manned VTOL aerial vehicle 100. In some embodiments, the visible spectrum imaging module 116 may comprise a plurality of rearward-facing cameras 189. Each rearward-facing camera 189 may have different (but possibly overlapping) fields of view to capture images of different regions visible behind the body 102 of the manned VTOL aerial vehicle 100.

The visible spectrum imaging module 166 comprises an event-based camera 173. The event-based camera 173 may be as described in “Event-based Vision: A Survey”, G. Gallego et al., (2020), IEEE Transactions on Pattern Analysis and Machine Intelligence, doi: 10.1109/TPAMI.2020.3008413, the content of which is incorporated herein by reference in its entirety.

The at least one processor 132 may execute the described visual odometry using the event-based camera 173. The at least one processor 132 may execute visual odometry as described in “Real-time Visual-Inertial Odometry for Event Cameras using Keyframe-based Nonlinear Optimization”, Rebecq, Henri & Horstschaefer, Timo & Scaramuzza, Davide, (2017), 10.5244/C.31.16, the content of which is incorporated herein by reference in its entirety.

The imaging module 164 comprises a Light Detection and Ranging (LIDAR) system 174. The LIDAR system 174 is configured to generate LIDAR data associated with at least a portion of the region around the manned VTOL aerial vehicle 100. The image data comprises the LIDAR data. The LIDAR system 174 comprises a LIDAR scanner 177. In particular, the LIDAR system 174 comprises a plurality of LIDAR scanners 177. The LIDAR scanners 177 may be distributed across the body 102 of the manned VTOL aerial vehicle 100. The LIDAR system 174 comprises a solid-state scanning LIDAR sensor 169. The LIDAR system 174 comprises a one-dimensional LIDAR sensor 171. The one-dimensional LIDAR sensor 171 may be in the form of a non-scanning LIDAR sensor.

The imaging module 164 comprises a Radio Detecting and Ranging (RADAR) system 175. The RADAR system 175 is configured to generate RADAR data associated with at least a portion of the region around the manned VTOL aerial vehicle 100. The image data comprises the RADAR data. The RADAR system 175 comprises a RADAR sensor 179. In particular, the RADAR system 175 comprises a plurality of RADAR sensors 179. The RADAR system 175 comprises a radar altimeter 163. The RADAR sensors 179 may be distributed across the body 102 of the manned VTOL aerial vehicle 100.

The RADAR system 175 is configured to generate a range-doppler map. The range-doppler map may be indicative of a position and a speed of the object 113. The sensor data may comprise the range-doppler map.

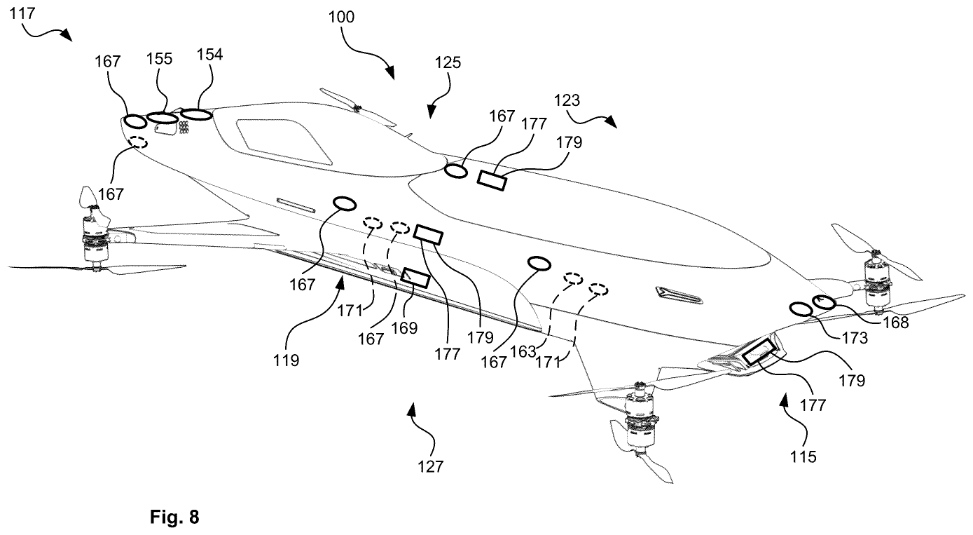

FIG. 8 is a perspective view of the manned VTOL aerial vehicle 100 showing example positioning of a plurality of components of the sensing system 120, according to some embodiments. The manned VTOL aerial vehicle 100 comprises a front portion 115. The manned VTOL aerial vehicle 100 comprises a rear portion 117. The manned VTOL aerial vehicle 100 comprises a first lateral portion 119. The manned VTOL aerial vehicle 100 comprises a second lateral portion 123. The manned VTOL aerial vehicle 100 comprises an upper portion 125. The manned VTOL aerial vehicle 100 comprises a lower portion 127.

The rear portion 117 comprises a plurality of sensors. The sensors may be part of the sensing system 120. For example, as illustrated in FIG. 8, the rear portion 117 comprises a plurality of visible spectrum cameras 167. The rear portion 117 may comprise a rearward-facing camera (e.g. a rearward-facing visible spectrum camera). Alternatively, the rear portion 117 may comprise the downward-facing camera 170. The rear portion 117 comprises the network interface 155. The rear portion comprises the GNSS module 154.

The front portion 115 comprises a plurality of sensors. The sensors may be part of the sensing system 120. For example, as illustrated in FIG. 8, the front portion 115 comprises a visible spectrum camera 167. Specifically, the front portion 115 comprises the forward-facing camera 168. The front portion 115 comprises the event-based camera 173. In some embodiments, the event-based camera 173 comprises the forward-facing camera 168. The front portion 115 comprises a LIDAR scanner 177. The front portion 115 comprise a RADAR sensor 179.

The first lateral portion 119 may be a right-side portion of the manned VTOL aerial vehicle 100. The first lateral portion 119 comprises a visible spectrum camera 167. Specifically, first lateral portion 119 comprises a plurality of visible spectrum cameras 167. One or more of these may be the laterally facing camera 165 previously described. The first lateral portion 119 comprises a solid state scanning LIDAR sensor 169. The first lateral portion 119 comprises a LIDAR scanner 177. The first lateral portion 119 comprises a RADAR sensor 179.

The second lateral portion 123 may be a left-side portion of the manned VTOL aerial vehicle 100. The second lateral portion 123 may comprise the same or similar sensors as the first lateral portion 119.

The upper portion 125 comprises a plurality of sensors. The sensors may be part of the sensing system 120. The upper portion 125 comprises a visible spectrum camera 167. The upper portion 125 comprises a LIDAR scanner 177. The upper portion 125 comprises a RADAR sensor 179.

The lower portion 127 comprises a plurality of sensors. The sensors may be part of the sensing system 120. The lower portion comprises a visible spectrum camera 167. The visible spectrum camera 167 of the lower portion may assist with landing area monitoring and speed estimation using optical flow. The lower portion comprises the one-dimensional LIDAR sensor 171. The lower portion comprises a radar altimeter 163. The radar altimeter 163 may assist with vertical terrain monitoring. The lower portion comprises a one-dimensional LIDAR sensor (not shown). The one-dimensional LIDAR sensor may assist with landing the manned VTOL aerial vehicle 100. The lower portion 127 may also house the power source 130. For example, where the power source 130 comprises one or more batteries, the one or more batteries may be housed in the lower portion 127.

In some embodiments, the aerial vehicle system 101 comprises a plurality of additional manned VTOL aerial vehicles 100A-N. There may be N additional manned VTOL aerial vehicles 100A-N. Each of the manned VTOL aerial vehicles 100A-N may comprise similar or the same features as those described with reference to the manned VTOL aerial vehicle 100. The manned VTOL aerial vehicle 100 may be referred to as a first manned VTOL aerial vehicle 100. Each of the manned VTOL aerial vehicles 100A-N may be referred to with a reference numeral (e.g. a second manned VTOL aerial vehicle 100A, a third manned VTOL aerial vehicle 100B, . . . and an (N+1)th manned VTOL aerial vehicle 100N. Similarly, each feature of the additional manned VTOL aerial vehicles 100A-N may be referred to with a reference numeral that corresponds to the reference numeral of that manned VTOL aerial vehicle 100A-N. For example, the second manned VTOL aerial vehicle 100A comprises at least one second processor 132A, second memory 134 etc.

### Region Infrastructure

Referring again to FIG. 3, the aerial vehicle system 101 comprises a central server system 103. The central server system 103 is configured to communicate with the manned VTOL aerial vehicle 100 via the communication network 105. The central server system 103 is configured to communicate with each of the additional manned VTOL aerial vehicles 100A-N via the communication network 105. The communication network 105 may be as described herein. Examples of a suitable communication network include a wireless local area network (WLAN) such as Wi-Fi (IEEE 82.15.1) or Zigbee (IEE 802.15.4), a wireless wide area network (WWAN) such as cellular 4G LTE and 5G or another cellular network connection, low power wide area networks (LPWAN) such as SigFox and Lora, Bluetooth™ and/or other near field radio communication. In some embodiments, the communication network 105 is separated into sub-networks. For example, the communication network 105 may be separated into a first sub-network and a second sub-network. A sub-network may be associated with a respective purpose and/or entity. For example, a team associated with the manned VTOL aerial vehicle 100 may have a dedicated sub-network over which to communicate.

The central server system 103 comprises at least one central server system processor 220. The at least one central server system processor 220 is configured to be in communication with central server system memory 222.

The central server system 103 also comprises an internal server system communication network (not shown). The internal server system communication network is a wired network. The internal server system communication network connects the at least one central server system processor 220, central server system memory 222 and other components of the central server system 103. The internal server system communication network may comprise a serial link, Ethernet network, a controller area network (CAN) or another network.

The at least one central server system processor 220 is configured to execute central server system program instructions stored in central server system memory 222 to cause the at least one central server system processor 220 to function as described herein.

In some embodiments, the central server system program instructions are in the form of program code. The at least one central server system processor 220 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The central server system program instructions comprise a state estimating module 224.

Central server system memory 222 may comprise one or more volatile or non-volatile memory types. For example, central server system memory 222 may comprise one or more of random access memory (RAM), read-only memory (ROM), electrically erasable programmable read-only memory (EEPROM) or flash memory. Central server memory 222 is configured to store program code accessible by the at least central server system one processor 220. The program code may comprise executable program code modules. In other words, central server system memory 222 is configured to store executable code modules configured to be executable by the at least one central server system processor 220. The executable code modules, when executed by the at least one central server system processor 220 cause the at least one central server system processor 220 to perform certain functionality, as described herein. In the illustrated embodiment, the central server system state estimating module 224 is in the form of program code stored in the central server system memory 222.

The central server system state estimating module 224 is to be understood to be one or more software programs. The central server system state estimating module 224 may, for example, be represented by one or more functions in a programming language, such as C++, C, C#, Python or Java. The resulting source code may be compiled and stored as computer executable instructions on central server system memory 222 that are in the form of the relevant executable code module.

The central server system 103 comprises a central server system communication system 226. The central server system communication system 226 is configured to enable the central server system 103 to communicate with other computing devices. The central server system 103 is configured to communicate with the manned VTOL aerial vehicle 100. In particular, the central server system 103 is configured to communicate with the manned VTOL aerial vehicle 100 using the central server system communication system 226. The central server system communication system 226 may comprise a wireless communication system.

In some embodiments, the central server system 103 is configured to communicate with the manned VTOL aerial vehicle 100 using the central server system communication system 226 and the communication network 105. The communication network 105 may be as previously described. In some embodiments, the central server system 103 is configured to communicate with a plurality of manned VTOL aerial vehicles 100. The central server system 103 may be configured to communicate with each of the plurality of manned VTOL aerial vehicles 100 simultaneously. The central server system 103 is configured to communicate with one or more of the manned VTOL aerial vehicles 100A-N using the central server system communication system 226.

The central server system 103 is configured to communicate with an external sensing system 199. In particular, the central server system 103 is configured to communicate with the external sensing system 199 using the central server system communication system 226. In some embodiments, the central server system 103 is configured to communicate with the external sensing system 199 using the central server system communication system 226 and the communication network 105. In some embodiments, the central server system communication system 226 is or includes a wired communication system (i.e. a non-wireless communication system). In these embodiments, the central server system 103 is physically connected to all or part of the external sensing system 199. In some embodiments, the central server system 103 comprises the external sensing system 199. In some embodiments, the central server system communication system 226 comprises a dedicated short-range communication system. The DSRC system is configured to enable the central server system 103 to communicate with the manned VTOL aerial vehicle 100.

The central server system 103 is configured to communicate with a repeater 107. The repeater 107 may be referred to as a trackside repeater. The central server system 103 is configured to communicate with the repeater 107 using the central server system communication system 226. In some embodiments, the central server system 103 is configured to communicate with the repeater 107 using the central server system communication system 226 and the communication network 105. For example, the central server system 103 may be connected to the repeater 107 (or one or more other ground-based components) via a wireless or Gigabit Ethernet network.

Similarly, the central server system 103 may be configured to communicate with one or more flight engineer stations. The flight engineer stations may be stations at which flight engineers can monitor telemetry associated with the manned VTOL aerial vehicle 100. The central server system 103 may be configured to communicate with one or more pilot stations. The pilot stations may stations at which pilots can pilot the manned VTOL aerial vehicle 100, or monitor telemetry associated with the manned VTOL aerial vehicle 100. The central server system 103 may communicate with the one or more flight engineer stations and/or the one or more pilot stations using the communication network 105. As described herein, the communication network 105 may comprise one or more wired and/or wireless communication networks. Thus, the central server system 103 may communicate with the one or more flight engineer stations and/or the one or more pilot stations using a wired network such as a Gigabit Ethernet network, or a wireless network such as a Wi-Fi network. The central server system 103, one or more flight engineer stations and the one or more pilot stations may be connected via a layer 3 switch.

The central server system 103 runs middleware applications to handle aircraft telemetry and control like data transfer and parsing. The central server system 103 communicates with cloud synchronization software to create data backups.

The central server system 103 is configured to process vehicle data provided to the central server system 103 by the manned VTOL aerial vehicle 100. The central server system 103 is configured to process vehicle data provided to the central server system 103 by the one or more of the manned VTOL aerial vehicles 100A-N. The central server system 103 is also configured to provide central server data to the manned VTOL aerial vehicle 100. The central server system 103 is configured to provide central server data to one or more of the manned VTOL aerial vehicles 100A-N.

The central server system 103 may comprise a database 133. Alternatively, the central server system 103 may be in communication with the database 133 (e.g. via a network such as the communication network 105). The database 133 may therefore be a cloud-based database. The central server system 103 is configured to store the vehicle data in the database 133. The central server system 103 is configured to store the central server data in the database 133.

The manned VTOL aerial vehicle 100 is operable to fly around a track 230 (e.g. as shown in FIG. 3A). The track 230 may be, or may form part of, the region described herein. The central server system 103 is configured to communicate information regarding the track 230 to the manned VTOL aerial vehicle 100. The central server system 103 is configured to communicate information regarding the track 230 to one or more of the manned VTOL aerial vehicles 100A-N.

The aerial vehicle system 101 may also comprise the repeater 107. The repeater 107 is configured to repeat wireless signals generated by the manned VTOL aerial vehicle 100, one or more of the manned VTOL aerial vehicles 100A-N and/or the central server system 103 (i.e. the central server system communication system 226) so that the manned VTOL aerial vehicle 100, one or more of the manned VTOL aerial vehicles 100A-N and the central server system 103 can communicate at further distances than would be enabled without the repeater 107. In some embodiments, the aerial vehicle system 101 comprises a plurality of repeaters 107.

The aerial vehicle system 101 comprises the external sensing system 199. The external sensing system 199 is configured to generate external sensing system data. The external sensing system data may relate to one or more of the manned VTOL aerial vehicle 100 and the region within which the manned VTOL aerial vehicle 100 is located. The external sensing system data may relate to one or more of the manned VTOL aerial vehicles 100A-N and the region. The external sensing system 199 comprises an external sensing system sensor 228. The external sensing system 199 comprises an external sensing system imaging system 197. In some embodiments, the external sensing system sensor 228 comprises the external sensing system imaging system 197. The external sensing system imaging system 197 is configured to generate external sensing system image data. For example, the external sensing system imaging system 197 may comprise one or more of an external LIDAR system configured to generate external LIDAR data, an external RADAR system configured to generate external RADAR data and an external visible spectrum imaging system configured to generate external visible spectrum image data.

The external sensing system 199 may comprise one or more of an external LIDAR system, an external RADAR system and an external visible spectrum camera. The external sensing system 199 is configured to generate the external sensing system data based at least in part on inputs received by the external sensing system sensor 228 (e.g. the external sensing system imaging system 197). For example, in some embodiments, the external sensing system 199 is configured to generate point cloud data. This may be referred to as additional point cloud data, as it is additional to the point cloud data generated by the manned VTOL aerial vehicle 100 itself.

The external sensing system 199 is configured to provide the external sensing system data to the central server system 103 and/or the manned VTOL aerial vehicle 100 via the communication network 105 (and the repeater 107 where necessary). The external sensing system 199 may comprise an external sensing system communication system (not shown). The external sensing system communication system may enable the external sensing system 199 to communicate with the central server system 103 and/or the manned VTOL aerial vehicle 100 (e.g. via the communication network 105). Therefore, the external sensing system communication system may enable the external sensing system 199 to provide the external sensing system data to the central server system 103 and/or the manned VTOL aerial vehicle 100.

In some embodiments, the external sensing system 199 may be considered part of the central server system 103. In some embodiments, the central server system 103 may provide the external sensing system data to the manned VTOL aerial vehicle 100 (e.g. via the communication network 105). In some embodiments, the central server system data comprises some or all of the external sensing system data.

In some embodiments, the at least one processor 132 is configured to receive the external LIDAR data, the external RADAR data and the external visible spectrum imaging data. The external LIDAR data may comprise an external region point cloud representing the region.

The aerial vehicle system 101 also comprises one or more other aircraft 109. The other aircraft 109 may be configured to communicate with the manned VTOL aerial vehicle 100 via the communication network 105 and/or the repeater 107. For example, the aerial vehicle system 101 may also comprise a spectator drone 111. The spectator drone 111 may be configured to communicate with the manned VTOL aerial vehicle 100 via the communication network 105 and/or the repeater 107.

In some embodiments, the spectator drone 111 is configured to generate additional image data. The additional image data may comprise additional three-dimensional data. For example, the spectator drone 111 may comprise a drone LIDAR system and/or another drone imaging system capable of generating the additional three-dimensional data. The additional three-dimensional data may be in the form of one or more of a point cloud (i.e. it may be point cloud data) and a depth map (i.e. it may be depth map data). In some embodiments, the additional image data comprises one or more of the additional three-dimensional data, additional visible spectrum image data, additional LIDAR data, additional RADAR data and additional infra-red image data. The spectator drone 111 is configured to provide the additional image data to the central server system 103. The spectator drone 111 may provide the additional image data directly to the central server system 103 using the communication network 105. Alternatively, the spectator drone 111 may provide the additional image data to the central server system 103 via one or more of the repeaters 107. The central server system 103 is configured to store the additional image data in the database 133. The additional image data may be used to generate the three-dimensional model described herein.

In some embodiments, the spectator drone 111 is configured to be a repeater. Therefore, the manned VTOL aerial vehicle 100 may communicate with the central server system 103 via the spectator drone 111. Similarly, the central server system 103 may communicate with the manned VTOL aerial vehicle 100 via the spectator drone 111. As such, the spectator drone 111 may be considered to be a communication relay or a communication backup (e.g. if one of the repeaters 107 fails).

The aerial vehicle system 101 comprises a region mapping system 290. The region mapping system 290 is configured to generate region mapping system data. In some embodiments, the region mapping system 290 is configured to generate the three-dimensional model of the region, based at least in part on the region mapping system data. The region mapping system 290 may comprise one or more of a region mapping camera system configured to generate visible spectrum region data, a region mapping LIDAR system configured to generate LIDAR region data and a region mapping RADAR system configured to generate RADAR region data. The region mapping system data comprises one or more of the visible spectrum region data, the LIDAR region data and the RADAR region data.

The region mapping system 290 (e.g. at least one region mapping system processor) is configured to determine the three-dimensional model of the region based at least in part on the region mapping system data (e.g. the visible spectrum region data, the LIDAR region data and the RADAR region data). In some embodiments, the region mapping system 290 is configured to process the visible spectrum region data to generate a region depth map. In some embodiments, the region mapping system 290 is configured to process the LIDAR data to determine an initial region point cloud.

The region mapping system 290 generates a three-dimensional occupancy grid based at least in part on the region mapping system data. For example, the region mapping system 290 determines the three-dimensional occupancy grid based at least in part on the region depth map and/or the initial region point cloud. The three-dimensional occupancy grid comprises a plurality of voxels. Each voxel is associated with a voxel probability that is indicative of a probability that a corresponding point of the region comprises an object and/or surface.

The three-dimensional occupancy grid may be an Octomap. In some embodiments, the region mapping system 290 generates the three-dimensional occupancy grid as is described in “OctoMap: An efficient probabilistic 3D mapping framework based on octrees”, Hornung, Armin & Wurm, Kai & Bennewitz, Maren & Stachniss, Cyrill & Burgard, Wolfram, (2013), Autonomous Robots. 34. 10.1007/s10514-012-9321-0 the content of which is incorporated by reference in its entirety.

The region mapping system 290 is configured to provide the three-dimensional model of the region to the manned VTOL aerial vehicle 100, one or more of the manned VTOL aerial vehicles 100A-N and/or the central server system 103. In some embodiments, the central server system 103 comprises the region mapping system 290. The central server system 103 is configured to store the three-dimensional model of the region in central server system memory 222. In some embodiments, the central server system data comprises the three-dimensional model of the region.

As previously described, the manned VTOL aerial vehicle 100 may be used in manned VTOL aerial vehicle racing. FIG. 3A is a block diagram of the aerial vehicle system 101, according to some embodiments, showing an example manned VTOL aerial vehicle track 230. The track 230 may correspond to the region described herein. The manned VTOL aerial vehicle 100 is configured to race one or multiple other manned VTOL aerial vehicles 100A-N (i.e. 100A, 100B, 100C, . . . , 100N) around the track 230. It will be understood that although the track 230 is shown as two-dimensional, the track 230 may be a three-dimensional track.

As previously described, the external sensing system 199 comprises the external sensing system sensor 228. The external sensing system sensor 228 is configured to generate external sensing system data. The external sensing system data generated by the external sensing system sensor 228 (and therefore the external sensing system 199) may be referred to as external sensing system sensor data. Alternatively, the sensor data generated by the external sensing system sensor 228 (and therefore the external sensing system 199) may be referred to as sensor data.

Referring to FIG. 7, the external sensing system sensor 228 comprises at least one sensor processor 234. The at least one sensor processor 234 is configured to be in communication with sensor memory 236. The external sensing system sensor 228 comprises a sensor module 232. The sensor module 232 may be referred to as an external sensing system sensor module. The sensor module 232 is configured to generate sensor data. The sensor data may be referred to as external sensing system sensor data. The central server system data comprises the external sensing system sensor data. The sensor module 232 is configured to communicate with the at least one sensor processor 234. In some embodiments, the sensor module 232 is configured to provide sensor data to the at least one sensor processor 234. In some embodiments, the at least one sensor processor 234 is configured to receive the sensor data from the sensor module 232. In some embodiments, the at least one sensor processor 234 is configured to retrieve the sensor data from the sensor module 232. The at least one sensor processor 234 is configured to store the sensor data in the sensor memory 236. In some embodiments, the at least one sensor processor 234 is configured to provide the sensor data to the central server system 103.

In some embodiments, the sensor module 232 comprises an external LIDAR module. The external LIDAR module is configured to generate external LIDAR data. The external LIDAR data is associated with the region. In particular, the external LIDAR data is associated with the region around the manned VTOL aerial vehicle 100 at a particular point in time.

In some embodiments, the sensor module 232 comprises an external visible spectrum camera. The external visible spectrum camera is configured to generate external sensing system visible spectrum data. The external sensing system visible spectrum data is associated with the region. In particular, the external sensing system visible spectrum data is associated with the region around the manned VTOL aerial vehicle 100 at a particular point in time.

In some embodiments, the external sensing system sensor module 232 comprises an external RADAR module. The external RADAR module is configured to generate external RADAR data. The external RADAR data is associated with the region. In particular, the external RADAR data is associated with the region around the manned VTOL aerial vehicle 100 at a particular point in time.

The at least one sensor processor 234 is configured to execute sensor program instructions stored in sensor memory 236 to cause the external sensing system sensor 228 to function as described herein. In other words, the sensor program instructions are accessible by the at least one sensor processor 234, and are configured to cause the at least one sensor processor 234 to function as described herein.

In some embodiments, the sensor program instructions are in the form of program code. The at least one sensor processor 234 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The sensor program instructions comprise a sensor state estimating module (not shown). The sensor state estimating module is configured to determine a state estimate of an object. For example, the sensor state estimating module is configured to determine an object state estimate of the object 113, or a state estimate of the manned VTOL aerial vehicle 100, as is described in more detail herein.

Sensor memory 236 may comprise one or more volatile or non-volatile memory types. For example, sensor memory 236 may comprise one or more of random access memory (RAM), read-only memory (ROM), electrically erasable programmable read-only memory (EEPROM) or flash memory. Sensor memory 236 is configured to store program code accessible by the at least one sensor processor 234. The program code may comprise executable program code modules. In other words, sensor memory 236 is configured to store executable code modules configured to be executable by the at least one sensor processor 234. The executable code modules, when executed by the at least one sensor processor 234 cause the at least one sensor processor 234 to perform certain functionality, as described herein. In the illustrated embodiment, the sensor state estimating module is in the form of program code stored in the memory 134.

The sensor state estimating module is to be understood to be one or more software programs. It may, for example, be represented by one or more functions in a programming language, such as C++, C, C#, Python or Java. The resulting source code may compiled and stored as computer executable instructions on sensor memory 236 that are in the form of the sensor state estimating module.

Sensor memory 236 is also configured to store a three-dimensional model. The three-dimensional model may be the three-dimensional model of the region. That is, the three-dimensional model may represent the region. The three-dimensional model may have an orientation that corresponds with that of the region, and surface of the three-dimensional model may correspond to surfaces of the region. In some embodiments, the three-dimensional model is a three-dimensional model of the track 230.

In the embodiments illustrated in FIG. 3A, the external sensing system 199 comprises a plurality of external sensing system sensors 228. The external sensing system sensors 228 are distributed at spaced locations around the track 230. The plurality of external sensing system sensors 228 may comprise a plurality of different types of sensors. For example, the plurality of external sensing system sensors 228 may comprise one or more external sensing system ranged imaging/sensing devices or cameras (e.g. infra-red cameras, visible spectrum cameras, LIDAR sensor modules, RADAR sensor modules etc.) and/or external sensing system audio sensors (e.g. microphones).

The aerial vehicle system 101 comprises an autonomous vehicle 181. The autonomous vehicle 181 comprises at least one autonomous vehicle processor (not shown). The autonomous vehicle 181 comprises autonomous vehicle memory (not shown). The at least one autonomous vehicle processor is configured to be in communication with the autonomous vehicle memory. The autonomous vehicle 181 comprises an autonomous vehicle communication system (not shown). The autonomous vehicle 181 is configured to communicate with one or more of the manned VTOL aerial vehicle 100, one or more of the additional manned VTOL aerial vehicles 100A-N, the central server system 103, the aircraft 109 and the repeater 107 using the autonomous vehicle communication system. The autonomous vehicle 181 comprises an autonomous vehicle propulsion system (not shown). The autonomous vehicle propulsion system is carried by the autonomous vehicle 181 to propel the autonomous vehicle 181 during flight.

The at least one autonomous vehicle processor is configured to execute autonomous vehicle program instructions stored in autonomous vehicle memory to cause the autonomous vehicle 181 to function as described herein. In particular, the at least one autonomous vehicle processor is configured to execute the autonomous vehicle program instructions to cause the at least one autonomous vehicle processor to function as described herein. In other words, the program instructions are accessible by the at least one autonomous vehicle processor, and are configured to cause the at least one autonomous vehicle processor to function as described herein.

In some embodiments, the autonomous vehicle program instructions are in the form of autonomous vehicle program code. The at least one autonomous vehicle processor comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code.

Autonomous vehicle memory may comprise one or more volatile or non-volatile memory types. For example, memory 134 may comprise one or more of random access memory (RAM), read-only memory (ROM), electrically erasable programmable read-only memory (EEPROM) or flash memory. Autonomous vehicle memory is configured to store autonomous vehicle program code accessible by the at least one autonomous vehicle processor. The autonomous vehicle program code may comprise executable program code modules. In other words, autonomous vehicle memory is configured to store executable code modules configured to be executable by the at least one autonomous vehicle processor. The executable code modules, when executed by the at least one autonomous vehicle processor cause the at least one autonomous vehicle processor to perform certain functionality, as described herein.

### Computer-Implemented Method 900

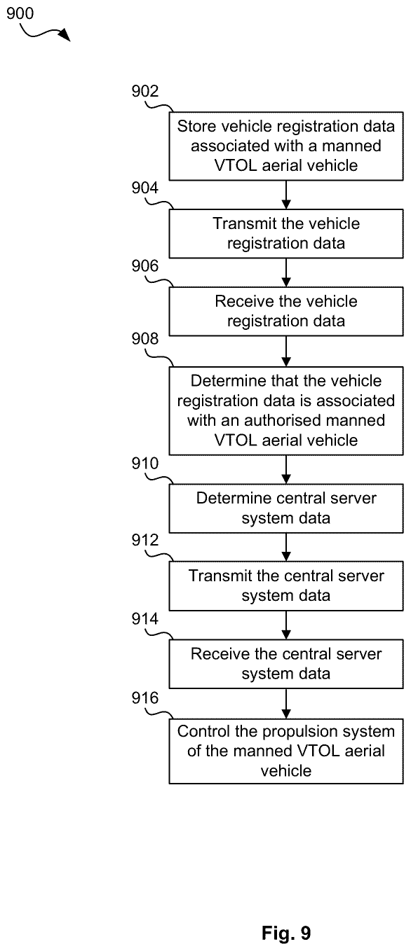

FIG. 9 is a process flow diagram illustrating a computer-implemented method 900. The computer-implemented method 900 is for determining an authorisation status of the manned VTOL aerial vehicle 100. At least some of the computer-implemented method 900 is performed by the central server system 103. In particular, at least some of the computer-implemented method 900 is performed by the at least one central server system processor 220.

FIG. 9 is to be understood as a blueprint for one or more software programs and may be implemented step-by-step, such that each step in FIG. 9 may, for example, be represented by a function in a programming language, such as C++, C, C#, Python or Java. The resulting source code is then compiled and stored as computer executable instructions on central server system memory 222.

The manned VTOL aerial vehicle 100, as described herein, is configured to store vehicle data, and to transmit vehicle data via the vehicle communication system 122. The vehicle data may comprise some or all of the sensor data described herein.

The vehicle data may comprise vehicle registration data. The vehicle registration data may comprise vehicle identification data. The vehicle identification data comprises data associated with the identity of the vehicle. For example, the vehicle identification data may comprise one or more of a number indicative of the identity of the manned VTOL aerial vehicle 100 and a message signed by a private key of the vehicle.

The vehicle registration data may comprise vehicle performance data. In some embodiments, the vehicle performance data comprises the sensor data. In some embodiments, the vehicle performance data comprises vehicle diagnostic data, as is described herein. The diagnostic data is associated with one or more systems of the manned VTOL aerial vehicle 100.

In some embodiments, the vehicle performance data comprises vehicle firmware data. The vehicle firmware data indicates a firmware version of the firmware of the manned VTOL aerial vehicle 100. The vehicle firmware data can be used to verify the authenticity of the firmware of the manned VTOL aerial vehicle 100. For example, the vehicle firmware data may comprise a digital signature of an issuing authority of the vehicle firmware data.

In some embodiments, the vehicle performance data comprises pilot biometric data. As described herein, the pilot biometric data is recorded via the pilot biometric sensing system 131 as is described herein.

At 902, the at least one processor 132 of the manned VTOL aerial vehicle stores the vehicle registration data. The vehicle registration data is associated with the manned VTOL aerial vehicle 100, as described herein. The at least one processor 132 stores the vehicle registration data in memory 134.

At 904, the at least one processor 132 retrieves, from memory 134, the vehicle registration data. The at least one processor 132 transmits the vehicle registration data using the communication system 122. Thus, the at least one processor 132 wirelessly transmits the vehicle registration data. In some embodiments, the at least one processor 132 encrypts the vehicle registration data prior to transmission. For example, the at least one processor 132 may encrypt the vehicle registration data using a public key of a public-private key pair of the central server system 103.

At 906, the at least one central server system processor 220 receives the vehicle registration data. As described herein, the vehicle registration data is associated with the manned VTOL aerial vehicle 100. The central server system 103 receives the vehicle registration data using the central server system communication system 226. In particular, the at least one central server system processor 220 receives the vehicle registration data using the central server system communication system 226. The at least one central server system processor 220 stores the vehicle registration data in the central server system memory 222.

At 908, the at least one central server system processor 220 determines that the vehicle registration data is associated with a manned VTOL aerial vehicle that is authorized to communicate with the central server system 103. A manned VTOL aerial vehicle that is authorized to communicate with the central server system 103 may be referred to as an authorised manned VTOL aerial vehicle. Thus, at 908, the at least one central server system processor 220 determines that the manned VTOL aerial vehicle 100 is an authorised manned VTOL aerial vehicle.

The central server system memory 222 may store authorized vehicle data. The authorized vehicle data indicates a number of manned VTOL aerial vehicles that are authorized to communicate with the central server system 103. Determining that the vehicle registration data is associated with a manned VTOL aerial vehicle that is authorized to communicate with the central server system 103 may comprise comparing one or more features of the vehicle registration data to one or more features of the authorized vehicle data. That is, in some embodiments, the at least one central server system processor 220 compares one or more aspects of the vehicle registration data to the authorized vehicle data to determine that the vehicle registration data is associated with a manned VTOL aerial vehicle that is authorized to communicate with the central server system 103.

For example, in some embodiments, the authorized vehicle data may comprise a numeric identifier for each manned VTOL aerial vehicle that is authorized to communicate with the central server system 103. The at least one central server system processor 220 may compare the vehicle identification data provided by the manned VTOL aerial vehicle 100 to the authorized vehicle data. In particular, the at least one central server system processor 220 may compare the number indicative of the identity of the manned VTOL aerial vehicle 100 to the numeric identifiers of the authorized vehicle data. The numeric identifiers of the authorized vehicle data comprising the number indicative of the identity of the manned VTOL aerial vehicle 100 indicates that the manned VTOL aerial vehicle 100 is an authorized vehicle.

In some embodiments, the at least one central server system processor 220 determines a privilege level of the manned VTOL aerial vehicle 100. For example, each numeric identifier for each vehicle of the authorized vehicle data may be associated with a respective privilege level. The privilege level of a vehicle of the authorized vehicle data may influence what information can be provided to that vehicle. For example, a vehicle of a lower privilege level may be restricted as to what information it can receive from the central server system 103. Conversely, higher priority or confidential data may be provided to vehicles of a higher privilege level compared to information that can be provided to vehicles of a lower privilege level.

At 910, the at least one central server system processor 220 determines central server system data. In particular, at 910, the at least one central server system processor 220 determines central server system data in response to determining that the manned VTOL aerial vehicle 100 is authorized to communicate with the central server system 103.

As described herein, in some embodiments, the central server system data comprises the three-dimensional model of the region. The three-dimensional model of the region may comprise the object state estimate described herein. The object state estimate is indicative of a state of an object within the region, as is described herein. The central server system data also comprises an object state estimate confidence metric that is indicative of an error associated with the object state estimate. The object state estimate confidence metric may be as described herein. The vehicle control data may be determined in cases where the central server system 103 determines that remote control of the manned VTOL aerial vehicle 100 is necessary, or desired.

In some embodiments, the central server system data comprises vehicle control data. Thus, at 910, the at least one central server system processor 220 determines vehicle control data in response to determining that the manned VTOL aerial vehicle 100 is authorized to communicate with the central server system 103.

As described herein, the vehicle data may comprise vehicle performance data. In some embodiments, the at least one central server system processor 220 compares the vehicle performance data to an operational condition. The operational condition may indicate a fault associated with the manned VTOL aerial vehicle. The at least one central server system processor 220 determines that the vehicle registration data satisfies the operational condition. For example, the vehicle performance data may comprise time series data of a current drawn by one of the propeller drive systems 114. In this case, the operating condition may be an upper current threshold. The upper current threshold may be a current value (e.g. measured in amperes). The central server processor 220 may compare the time series data of the current drawn by the one of the propeller drive systems 114 to the upper current threshold. The vehicle performance data may be considered to satisfy the operational condition if one of the values of the time series data of the current drawn by the one of the propeller drive systems 114 is greater than the upper current threshold. In some embodiments, the vehicle performance data may comprise a temperature of a propeller motor, a temperature of the control system 116 or a temperature of the one or more batteries. In these embodiments, the relevant operational condition may be a threshold temperature. In some embodiments, the vehicle performance data comprises a synthetic report about one or more sub-systems of the manned VTOL aerial vehicle. In some embodiments, the vehicle performance data comprises a synthetic report about one or more software modules. In some embodiments, the vehicle performance data comprises a measure of vehicle localization accuracy (i.e. a metric that provides insight about the uncertainty of the aircraft state estimate). In this case, the relevant operational condition may be a threshold uncertainty. In some embodiments, the vehicle performance data comprises vibration data. In these embodiments, the relevant operational condition may be a maximum vibration threshold (e.g. vibration amplitude and/or frequency). In some embodiments, the vehicle performance data comprises a radio communication signal strength metric. In these embodiments, the operational condition may be a magnitude of the signal strength or a difference between the signal strength and environmental noise. In some embodiments, the vehicle performance data comprises latency data associated with a latency of communication between the manned VTOL aerial vehicle 100 and another computing device (e.g. the central server system 103). In these embodiments, the relevant operational condition may be a latency threshold. In some embodiments, the vehicle performance data comprises bandwidth data associated with a bandwidth of the communication between the manned VTOL aerial vehicle 100 and another computing device (e.g. the central server system 103). In these embodiments, the relevant operational condition may be a bandwidth threshold.

In some embodiments, the vehicle control data comprises vehicle control program instructions. The at least one processor 132 of the manned VTOL aerial vehicle 100 is configured to receive the vehicle control program instructions and perform the vehicle control program instructions to control the manned VTOL aerial vehicle. The vehicle control program instructions may be configured to be performed by the at least one processor 132 to cause the at least one processor 132 to control the propulsion system 106 such that the manned VTOL aerial vehicle 100 lands. This may be for an emergency landing condition, as is described in more detail herein. In these cases, the vehicle control data may comprise a landing position vector.

The landing position vector may comprise a plurality of landing position vector elements. Each landing position vector element corresponds to a coordinate in the three-dimensional model coordinate system. Each landing position vector element therefore also corresponds to a coordinate in the three-dimensional region coordinate system, either directly, where the three-dimensional region coordinate system directly corresponds to the three-dimensional model coordinate system, or via the transformation operator where the coordinate systems do not directly correspond. The landing position vector is indicative of a position in the region where the manned VTOL aerial vehicle 100 is authorised to land. In an emergency condition, the landing position vector is indicative of a position in the region where the manned VTOL aerial vehicle 100 is required to land.

The at least one central server system processor 220 may determine the central server system data by retrieving the central server system data from the central server system memory 222. For example, where the central server system data comprises the three-dimensional model of the region, the at least one central server system processor 220 may retrieve the three-dimensional model of the region from the central server system memory 222. In some embodiments, the at least one central server system processor 220 may determine an updated three-dimensional model of the region based at least in part on the vehicle data. For example, the object 113 may have moved, and the vehicle data may reflect the movement of the object 113. The at least one central server system processor 220 can therefore update the position of the object in the three-dimensional model of the region based on the vehicle data, and provide the updated three-dimensional model to the manned VTOL aerial vehicle 100.

At 912, the at least one central server system processor 220 transmits the central server system data. In particular, the at least one central server system processor 220 wirelessly transmits the central server system data using the central server system communication system 226.

At 914, the manned VTOL aerial vehicle 100 receives the central server system data. In particular, the at least one processor 132 receives the central server system data using the communication system 122. The at least one processor 132 may store the central server system data in memory 134.

At 916, the at least one processor 132 controls the propulsion system 106. The at least one processor 132 controls the propulsion system based at least in part on the central server system data. As previously described, the central server system data may comprise control data. The at least one processor 132 may control the propulsion system 106 based at least in part on the control data. Also as described, the central server system data may comprise the three-dimensional model of the region, or an updated three-dimensional model of the region. The at least one processor 132 may therefore control the propulsion system 106 to avoid the object 113, based at least in part on the central server system data.

As described herein, the control data comprises the landing position vector. The at least one processor 132 controls the propulsion system 106 to land the manned VTOL aerial vehicle 100 within a landing zone of the region that is associated with the landing position vector. The landing zone may be a portion of the region that is defined with respect to the landing position vector. For example, the landing zone may be an area centred on the point of the region corresponding to the landing position vector. For example, the landing zone may be defined by a portion of the region with a pre-defined surface area, the portion of the region being centred on the point of the region corresponding to the landing position vector. Alternatively, the landing zone may be defined by a portion of the region that is within a certain number of metres of the point of the region corresponding to the landing position vector.

As described herein, the aerial vehicle system 101 comprises an autonomous vehicle 181. In some embodiments, the autonomous vehicle 181 receives the central server system data. In particular, the autonomous vehicle processor 183 receives the central server system data using the autonomous vehicle communication system. The autonomous vehicle processor controls the autonomous vehicle propulsion system, based at least in part on the central server system data. As described herein, the control data comprises the landing position vector. The autonomous vehicle processor 183 controls the propulsion system to land the autonomous vehicle 181 within a landing zone that is associated with the landing position vector.

### Computer-Implemented Method 1000

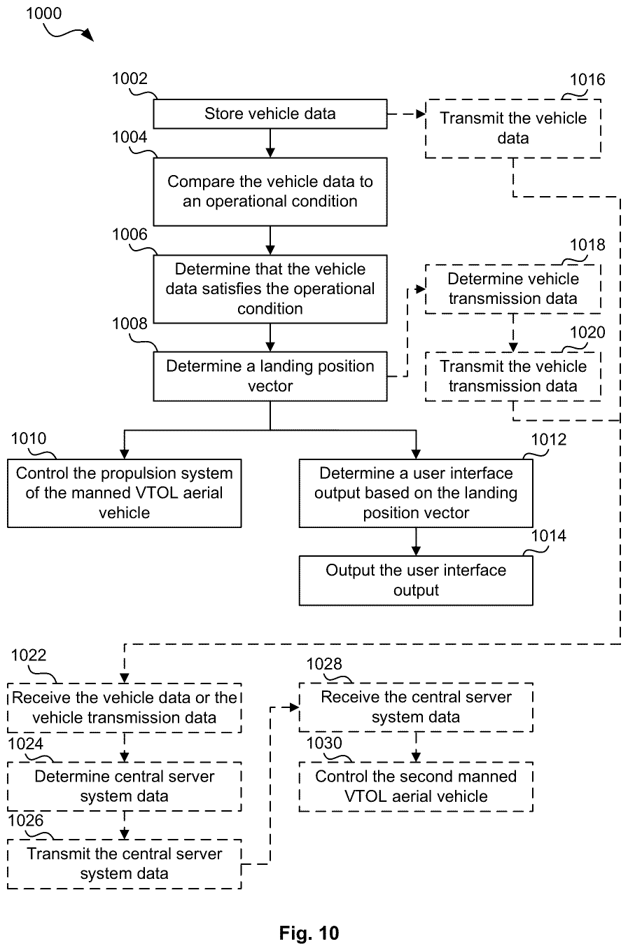

FIG. 10 is a process flow diagram illustrating a computer-implemented method 1000. In some embodiments, the computer-implemented method 1000 is for autonomously controlling the manned VTOL aerial vehicle 100. In some embodiments, the computer-implemented method 1000 is for guiding a pilot of the manned VTOL aerial vehicle 100. At least part of the computer-implemented method 1000 is performed by the manned VTOL aerial vehicle 100. In particular, at least part of the computer-implemented method 1000 is performed by the at least one processor 132 of the manned VTOL aerial vehicle 100.

FIG. 10 is to be understood as a blueprint for one or more software programs and may be implemented step-by-step, such that each step in FIG. 10 may, for example, be represented by a function in a programming language, such as C++, C, C#, Python or Java. The resulting source code is then compiled and stored as computer executable instructions.

The manned VTOL aerial vehicle 100, as described herein, is configured to store vehicle data, and to transmit vehicle data via the communication system 122. The vehicle data is associated with the manned VTOL aerial vehicle 100. In particular, the vehicle data is associated with one or more sub-systems of the manned VTOL aerial vehicle 100. For example, the vehicle data may comprise the sensor data, as described herein.

At 1002, the at least one processor 132 stores the vehicle data. The at least one processor 132 stores the vehicle data in memory 134.

At 1004, the at least one processor 132 compares the vehicle data to an operational condition. In particular, the at least one processor 132 compares at least part of the vehicle data to the operational condition. For example, the vehicle data may comprise time series data of a current drawn by one of the propeller drive systems 114. In this case, the operating condition may be an upper current threshold. The upper current threshold may be a current value (e.g. measured in amperes). The at least one processor 132 may compare the time series data of the current drawn by the one of the propeller drive systems 114 to the upper current threshold. The vehicle performance data may be considered to satisfy the operational condition if one of the values of the time series data of the current drawn by the one of the propeller drive systems 114 is greater than the upper current threshold.

At 1006, the at least one processor 132 determines that the vehicle data satisfies the operational condition. The vehicle performance data satisfying the operational condition may indicate than an emergency landing of the vehicle is necessary. For example, where two or more propeller drive systems 114 are inoperable, an emergency landing of the manned VTOL aerial vehicle 100 is advisable to minimise risk to the pilot and the manned VTOL aerial vehicle 100 itself.

At 1008, the at least one processor 132 determines a landing position vector. In particular, the at least one processor 132 determines the landing position vector in response to determining that the vehicle data satisfies the operational condition. The landing position vector may be as described herein. In some embodiments, the landing position vector is indicative of a safe landing position within the region.

In some embodiments, a plurality of landing position vectors are stored in memory 134, and the at least one processor 132 retrieves one of the plurality of landing position vectors based at least in part on the sensor data. For example, the at least one processor 132 may retrieve the landing position vector that is closest to the position estimate of the manned VTOL aerial vehicle 100 as indicated by the GNSS data.

In some embodiments, the at least one processor 132 determines the landing position vector based at least in part on the sensor data. For example, the sensor data may indicate a clear, flat ground area (e.g. via LIDAR data) and the at least one processor 132 may determine a landing position vector within the clear, flat ground area.

In some embodiments, the at least one processor 132 autonomously controls the propulsion system 106 of the manned VTOL aerial vehicle 100. The at least one processor 132 autonomously controls the propulsion system 106 to land the manned VTOL aerial vehicle 100.

In particular, at 1010, the at least one processor 132 controls the propulsion system 106 of the manned VTOL aerial vehicle 100. The at least one processor 132 controls the propulsion system 106 based at least in part on the landing position vector. The at least one processor 132 autonomously controls the propulsion system 106 to land the manned VTOL aerial vehicle within a landing zone that is associated with the landing position vector.

In some alternative embodiments, the pilot controls the propulsion system 106, via the pilot-operable controls 118, to land the manned VTOL aerial vehicle 100. In these embodiments, the at least one processor 132 provides one or more outputs using the user interface 129, to guide the pilot towards the landing zone.

In particular, at 1012, the at least one processor 132 determines a user interface output. The at least one processor 132 determines the user interface output based at least in part on the determined landing position vector.

The user interface output comprises a visual output. For example, the user interface output may comprise a marker that is displayed on the display, indicating a position of the landing position vector. The position of the marker on the display can be updated as the manned VTOL aerial vehicle 100 moves, and can guide the pilot to the landing position vector and/or the landing zone.

The user interface output comprises an audio output. For example, the user interface output may comprise a recorded message indicating that the pilot should pilot the manned VTOL aerial vehicle 100 to the landing zone and/or the landing position vector.

At 1014, the at least one processor 132 outputs the user interface output. The at least one processor 132 outputs the user interface output using the user interface 129. The pilot may then control the propulsion system 106, via the pilot-operable controls 118, to land the manned VTOL aerial vehicle 100 based on the user interface output.

In some embodiments, the at least one processor 132 transmits the vehicle data. At 1016, the at least one processor 132 retrieves the vehicle data from the memory 134. The at least one processor 132 transmits the vehicle data using the communication system 122.

In some embodiments, the at least one processor 132 determines vehicle transmission data. The vehicle transmission data is indicative of the vehicle data satisfying the operational condition. In particular, at 1018, the at least one processor 132 determines vehicle transmission data.

The communication system 122 of the manned VTOL aerial vehicle may be capable of transmitting data at a communication system bandwidth. As the communication system bandwidth can be a bottleneck when transmitting data from the manned VTOL aerial vehicle 100, it can be advantageous to minimise the amount of data to be transferred using the communication system 122. By determining and transmitting vehicle transmission data that is indicative of the vehicle data satisfying the operational condition, rather than transmitting the vehicle data in its entirety, the amount of data transmitted using the communication system 122 can be significantly reduced.

For example, in the above-mentioned case where the operating condition is an upper current threshold and the at least one processor 132 determines that one or more of the values of the time series data of the current drawn by the one of the propeller drive systems 114 is greater than the upper current threshold, the at least one processor 132 may generate a message indicating this. The vehicle transmission data may comprise the message, rather than the time series data of the current drawn by the one of the propeller drive systems 114. Thus, the size of the vehicle transmission data can be significantly less than that of the vehicle data. In some embodiments, the vehicle transmission data may comprise the landing position vector.

The at least one processor 132 stores the vehicle transmission data in the memory 134.

In some embodiments, the at least one processor 132 transmits the vehicle transmission data. At 1020, the at least one processor 132 retrieves the vehicle transmission data from memory 134. The at least one processor 132 transmits the vehicle transmission data using the communication system 122.

In some embodiments, at 1022, the at least one central server system processor 220 receives the vehicle data. In particular, the at least one central server system processor 220 receives the vehicle data using the central server system communication system 226.

In some embodiments, at 1022, the at least one central server system processor 220 receives the vehicle transmission data. In particular, the at least one central server system processor 220 receives the vehicle transmission data using the central server system communication system.

At 1024, the at least one central server system processor 220 determines central server system data. In embodiments where the at least one central server system processor 220 receives the vehicle data, the at least one central server system processor 220 determines the central server system data based on the vehicle data. In embodiments where the at least one central server system processor 220 receives the vehicle transmission data, the at least one central server system processor 220 determines the central server system data based on the vehicle transmission data. The central server system data comprises a second landing position vector. Thus, the at least one central server system processor 220 determines the second landing position vector. The second landing position vector is associated with a second manned VTOL aerial vehicle 100A.

As previously described, in some embodiments, the vehicle transmission data comprises the landing position vector. Where this is the case, the at least one central server system processor 220 may determine the central server system data based at least in part on the landing position vector. In particular, the at least one central server system processor 220 may determine the second landing position vector based at least in part on the landing position vector.

In some embodiments, the landing position vector and the second landing position vector are different. As the manned VTOL aerial vehicle 100 is landing in an emergency condition, its flight path may be unstable or relatively unpredictable. It can therefore be beneficial to ensure the second manned VTOL aerial vehicle 100A maintains a safe distance from the manned VTO aerial vehicle 100 when landing. This is achieved by ensuring the second landing position vector is different from the landing position vector. In other words, this is achieved by ensuring the second landing position vector is associated with a different part of the region than the landing position vector.

In some embodiments, the landing position vector and the second landing position vector are the same. In some cases, it can be advantageous to land the manned VTOL aerial vehicle 100 and the second manned VTOL aerial vehicle 100A in the same or a similar location of the region. For example, where there is a rapid change in weather, quickly landing two vehicles that are relatively close to each other in the region can be achieved by determining a common landing zone.

In some embodiments, the central server system data comprises an updated three-dimensional model of the region. That is, the at least one central server system processor 220 determines an updated three-dimensional model of the region.

In some embodiments, the central server system data comprises a second user interface output. That is, the at least one central server system processor 220 determines the second user interface output. The at least one central server system processor 220 determines the second user interface output based at least in part on the determined second landing position vector.

The second user interface output comprises a second visual output. For example, the second user interface output may comprise a second marker that is displayed on the second display of the second manned VTOL aerial vehicle 100A, indicating a position of the second landing position vector. The position of the second marker on the second display can be updated as the second manned VTOL aerial vehicle 100A moves, and can guide the pilot of the second manned VTOL aerial vehicle 100A to the second landing position vector and/or the second landing zone.

The second user interface output comprises a second audio output. For example, the second user interface output may comprise a recorded message indicating that the pilot should pilot the second manned VTOL aerial vehicle 100A to the second landing zone and/or the second landing position vector.

At 1026, the at least one central server system processor 220 transmits the central server system data. In particular, the at least one central server system processor 220 transmits the central server system data using the central server system communication system 226.

As described herein, in some embodiments, the aerial vehicle system 101 comprises the second manned VTOL aerial vehicle 100A. At 1028, the at least one second processor 132A of the second manned VTOL aerial vehicle 100A receives the central server system data. The at least one second processor 132A receives the central server system data using the second communication system 122A.

At 1030, the at least one second processor 132A controls the second manned VTOL aerial vehicle 100A. In some embodiments, at 1030, the at least one second processor 132A controls the propulsion system 106A of the second manned VTOL aerial vehicle 100A. In particular, the at least one second processor 132A controls the propulsion system 106A of the second manned VTOL aerial vehicle 100A to land the second manned VTOL aerial vehicle 100A within a second landing zone that is associated with the second landing position vector.

In some embodiments, at 1030, the at least one second processor 132A controls the second user interface 129A of the second manned VTOL aerial vehicle 100A. Controlling the second manned VTOL aerial vehicle 100A may comprise causing the second manned VTOL aerial vehicle 100A to output the second user interface output. Therefore, in some embodiments, at 1030, the at least one second processor 132A outputs the second user interface output. The at least one second processor 132A outputs the second user interface output using the second user interface 129A. The pilot may then control the second propulsion system 106A to land the second manned VTOL aerial vehicle 100A based on the second user interface output.

As described herein, the aerial vehicle system 101 comprises the autonomous vehicle 181. In some embodiments, the autonomous vehicle processor receives the central server system data. In particular, the autonomous vehicle processor receives the central server system data using the autonomous vehicle communication system.

The autonomous vehicle processor controls the autonomous vehicle 181 based at least in part on the central server system data. In particular, the autonomous vehicle processor controls the autonomous vehicle propulsion system based at least in part on the central server system data. In some embodiments, the autonomous vehicle 181 may be a media vehicle comprising a camera, that is configured to record aspects of the region and transmit them for display (e.g. to an audience of a race). In cases such as this, the autonomous vehicle processor may control the autonomous vehicle propulsion system to travel towards the manned VTOL aerial vehicle 100 to observe the manned VTOL aerial vehicle 100.

In some embodiments, the autonomous vehicle processor receives the vehicle data. In particular, the autonomous vehicle processor receives the vehicle data using the autonomous vehicle communication system.

The autonomous vehicle processor controls the autonomous vehicle based at least in part on the vehicle data. In particular, the autonomous vehicle processor 183 controls the autonomous vehicle propulsion system 189 based at least in part on the vehicle data. In cases such as this, the autonomous vehicle processor may control the autonomous vehicle propulsion system to travel towards the manned VTOL aerial vehicle 100 to observe the manned VTOL aerial vehicle 100.

In some embodiments, the autonomous vehicle processor receives the vehicle transmission data. In particular, the autonomous vehicle processor receives the vehicle transmission data using the autonomous vehicle communication system.

The autonomous vehicle processor controls the autonomous vehicle 181 based at least in part on the vehicle transmission data. In particular, the autonomous vehicle processor controls the autonomous vehicle propulsion system based at least in part on the vehicle transmission data. In cases such as this, the autonomous vehicle processor may control the autonomous vehicle propulsion system to travel towards the manned VTOL aerial vehicle 100 to observe the manned VTOL aerial vehicle 100.

### Computer-Implemented Method 1100

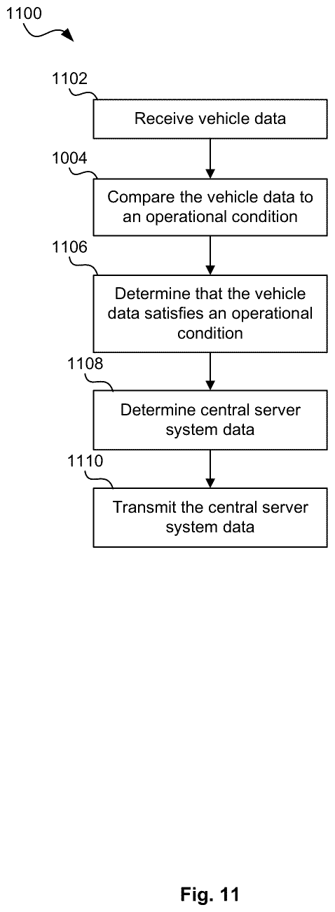

FIG. 11 is a process flow diagram illustrating a computer-implemented method 1100. In some embodiments, the computer-implemented method 1100 is for transmitting central server system data. In some embodiments, the computer-implemented method 1100 is for guiding a pilot of the manned VTOL aerial vehicle 100. At least part of the computer-implemented method 1100 is performed by the central server system 103. In particular, at least part of the computer-implemented method 1100 is performed by the at least one central server system processor 220 of the central server system 103.

FIG. 11 is to be understood as a blueprint for one or more software programs and may be implemented step-by-step, such that each step in FIG. 11 may, for example, be represented by a function in a programming language, such as C++, C, C#, Python or Java. The resulting source code is then compiled and stored as computer executable instructions on central server system memory 222.

The manned VTOL aerial vehicle 100, as described herein, is configured to store vehicle data, and to transmit vehicle data via the vehicle communication system 122. The vehicle data is associated with the manned VTOL aerial vehicle 100. In particular, the vehicle data is associated with one or more sub-systems of the manned VTOL aerial vehicle 100. For example, the vehicle data may comprise the sensor data, as described herein.

At 1102, the at least one central server system processor 220 receives the vehicle data. In particular, the at least one central server system processor 220 receives the vehicle data using the central server system communication system 226.

At 1104, the at least one central server system processor 220 compares the vehicle data to an operational condition. In particular, the at least one central server system processor 220 compares at least part of the vehicle data to the operational condition. For example, the vehicle data may comprise time series data of a current drawn by one of the propeller drive systems 114. In this case, the operating condition may be an upper current threshold. The upper current threshold may be a current value (e.g. measured in amperes). The at least one central server system processor 220 may compare the time series data of the current drawn by the one of the propeller drive systems 114 to the upper current threshold. The vehicle performance data may be considered to satisfy the operational condition if one of the values of the time series data of the current drawn by the one of the propeller drive systems 114 is greater than the upper current threshold.

The relevant operational condition can be imposed by limits associated with the three-dimensional model of the region. The relevant operational condition can be imposed by regulation, by the control system 116, limiting a maximum power usage (e.g. total battery current draw×voltage). The relevant operational condition can be imposed by regulation, by the control system 116, about a maximum speed or minimum/maximum altitude profile when accessing a landing area or pit stop area. The relevant operational condition can be imposed by a race flag. For example, the central server system 103 may report a failure of a system of one of the aircraft in the local area of the manned VTOL aerial vehicle 100. The central server system 103 may impose a specific speed limit and a minimum approaching distance of the relevant area.

At 1106, the at least one central server system processor 220 determines that the vehicle data satisfies the operational condition. The vehicle performance data satisfying the operational condition may indicate than an emergency landing of the vehicle is necessary. For example, where two or more propeller drive systems 114 are inoperable, an emergency landing of the manned VTOL aerial vehicle 100 is advisable to minimise risk to the pilot and the manned VTOL aerial vehicle 100 itself.

At 1108, the at least one central server system processor 220 determines central server system data. In particular, the at least one central server system processor 220 determines the central server system data in response to determining that the vehicle data satisfies the operational condition. The at least one central server system processor 220 determines the central server system data based at least in part on the vehicle data.

In some embodiments, the central server system data comprises a landing position vector. That is, at 1108, the at least one central server system processor 220 determines the landing position vector. The landing position vector may be as described herein. In some embodiments, the landing position vector is indicative of a safe landing position within the region.

In some embodiments, a plurality of landing position vectors are stored in central server system memory 222, and the at least one central server system processor 220 retrieves one of the plurality of landing position vectors based at least in part on one or more of the vehicle data, central server system data and external sensing system data. For example, the at least one central server system processor 220 may retrieve the landing position vector that is closest to the position estimate of the manned VTOL aerial vehicle 100 as indicated by the external sensing system data.

In some embodiments, the at least one central server system processor 220 determines the landing position vector based at least in part on the external sensing system data. For example, the external sensing system data may indicate a clear, flat ground area (e.g. via LIDAR data or the image data confirming the absence of an object or human in the landing area) and the at least one central server system processor 220 may determine a landing position vector within the clear, flat ground area.

In some embodiments, the central server system data comprises a second landing position vector. That is, at 1108, the at least one central server system processor 220 determines the second landing position vector. The second landing position vector may be as described herein. That is, the second landing position vector may be indicative of a position near which the second manned VTOL aerial vehicle 100A is to land. In some embodiments, the second landing position vector is indicative of a safe landing position within the region.

In some embodiments, a plurality of second landing position vectors are stored in central server system memory 222, and the at least one central server system processor 220 retrieves one of the plurality of second landing position vectors based at least in part on one or more of the vehicle data, central server system data and external sensing system data. For example, the at least one central server system processor 220 may retrieve the second landing position vector that is closest to the position estimate of the manned VTOL aerial vehicle 100 as indicated by the external sensing system data.

In some embodiments, the at least one central server system processor 220 determines the second landing position vector based at least in part on the external sensing system data. For example, the external sensing system data may indicate a clear, flat ground area (e.g. via LIDAR data) and the at least one central server system processor 220 may determine a second landing position vector within the clear, flat ground area.

In some embodiments, the landing position vector and the second landing position vector are different. As the manned VTOL aerial vehicle 100 is landing in an emergency condition, its flight path may be unstable or relatively unpredictable. It can therefore be beneficial to ensure the second manned VTOL aerial vehicle 100A maintains a safe distance from the manned VTO aerial vehicle 100 when landing. This is achieved by ensuring the second landing position vector is different from the landing position vector. In other words, this is achieved by ensuring the second landing position vector is associated with a different part of the region than the landing position vector.

In some embodiments, the landing position vector and the second landing position vector are the same. In some cases, it can be advantageous to land the manned VTOL aerial vehicle 100 and the second manned VTOL aerial vehicle 100A in the same or a similar location of the region. For example, where there is a rapid change in weather, quickly landing two vehicles that are relatively close to each other in the region can be achieved by determining a common landing zone.

In some embodiments, the central server system data comprises an updated three-dimensional model of the region. That is, at 1108, the at least one central server system processor 220 determines an updated three-dimensional model of the region. In some embodiments, the at least one central server system processor 220 determines the updated three-dimensional model based at least in part on the landing position vector. In some embodiments, the at least one central server system processor 220 determines the updated three-dimensional model based at least in part on the second landing position vector.

The central server system processor 220 may define one or more three-dimensional zones of the three-dimensional model. These zones can represent no-fly zones, through which the additional manned VTOL aerial vehicles 100A-N are not permitted to fly, at least temporarily. Again, as the manned VTOL aerial vehicle 100 is landing in an emergency condition, its flight path may be unstable or relatively unpredictable. The three-dimensional zones can accommodate for this, and ensure the additional manned VTOL aerial vehicles 100A-N maintain a safe distance from the manned VTO aerial vehicle 100 when landing.

In some embodiments, the central server system data comprises a user interface output. That is, at 1108, the at least one central server system processor 220 determines the user interface output. The at least one central server system processor 220 determines the user interface output based at least in part on the determined landing position vector.

The user interface output comprises a visual output. For example, the user interface output may comprise a marker that is displayed on the display of the manned VTOL aerial vehicle 100, indicating a position of the landing position vector. The position of the marker on the display can be updated as the manned VTOL aerial vehicle 100 moves, and can guide the pilot to the landing position vector and/or the landing zone.

The user interface output comprises an audio output. For example, the user interface output may comprise a recorded message indicating that the pilot should pilot the manned VTOL aerial vehicle 100A to the landing zone and/or the landing position vector.

In some embodiments, the central server system data comprises a second user interface output. That is, at 1108, the at least one central server system processor 220 determines a second user interface output. The at least one central server system processor 220 determines the second user interface output based at least in part on the determined second landing position vector.

The second user interface output comprises a visual output. For example, the second user interface output may comprise a second marker that is displayed on the second display of the second manned VTOL aerial vehicle 100A, indicating a position of the second landing position vector. The position of the second marker on the second display can be updated as the second manned VTOL aerial vehicle 100A moves, and can guide the pilot to the second landing position vector and/or the second landing zone.

The second user interface output comprises a second audio output. For example, the second user interface output may comprise a recorded message indicating that the pilot should pilot the second manned VTOL aerial vehicle 100A to the second landing zone and/or the second landing position vector.

In some embodiments, the central server data comprises restriction condition data. That is, at 108, the at least one central server system processor 220 determines restriction condition data. In some embodiments, the at least one central server system processor 220 determines the restriction condition data based at least in part on the determined landing position vector. The above-mentioned three-dimensional zones are an example of restriction condition data as vehicles are restricted from flying through the zones. In some embodiments, the at least one central server system processor 220 determines the restriction condition data based at least in part on the determined landing position vector and/or the determined second landing position vector.

At 1110, the at least one central server system processor 220 transmits the central server system data. In particular, the at least one central server system processor 220 transmits the central server system data using the central server system communication system 226.

The manned VTOL aerial vehicle 100 is configured to receive the central server system data. In particular, the at least one processor 132 is configured to receive the central server system data using the communication system 122.

The at least one processor 132 controls the manned VTOL aerial vehicle 100 based at least in part on the central server system data. In some embodiments, the at least one processor 132 controls the propulsion system 106 of the manned VTOL aerial vehicle 100. In particular, the at least one processor 132 controls the propulsion system 106 of the manned VTOL aerial vehicle 100 to land the manned VTOL aerial vehicle 100 within a landing zone that is associated with the landing position vector.

In some embodiments, the at least one processor 132 controls the user interface 129 of the manned VTOL aerial vehicle 100. Controlling the manned VTOL aerial vehicle 100 may comprise causing the manned VTOL aerial vehicle 100 to output the user interface output. Therefore, in some embodiments, the at least one processor 132 outputs the user interface output. The at least one processor 132 outputs the user interface output using the user interface 129. The pilot may then control the propulsion system 106 to land the manned VTOL aerial vehicle 100 based on the user interface output.

As described herein, the aerial vehicle system 101 comprises the autonomous vehicle 181. In some embodiments, the autonomous vehicle processor receives the central server system data. In particular, the autonomous vehicle processor receives the central server system data using the autonomous vehicle communication system.

The autonomous vehicle processor controls the autonomous vehicle 181 based at least in part on the central server system data. In particular, the autonomous vehicle processor controls the autonomous vehicle propulsion system based at least in part on the central server system data. For example, in some embodiments, the autonomous vehicle 181 may be a media vehicle comprising a camera, that is configured to record aspects of the region and transmit them for display (e.g. to an audience of a race). In cases such as this, the autonomous vehicle processor may control the autonomous vehicle propulsion system to travel towards the manned VTOL aerial vehicle 100 to observe the manned VTOL aerial vehicle 100.

As described herein, the aerial vehicle system 101 comprises a second manned VTOL aerial vehicle 100A. The second manned VTOL aerial vehicle 100 is configured to receive the central server system data. In particular, the at least one second processor 132A is configured to receive the central server system data using the second communication system 122A.

The at least one second processor 132A controls the second manned VTOL aerial vehicle 100 based at least in part on the central server system data. In some embodiments, the second at least one processor 132A controls the second propulsion system 106A of the second manned VTOL aerial vehicle 100A. In particular, the at least one second processor 132A controls the second propulsion system 106A of the second manned VTOL aerial vehicle 100A to land the second manned VTOL aerial vehicle 100A within a second landing zone that is associated with the second landing position vector.

In some embodiments, the at least one second processor 132A controls the second user interface 129A of the second manned VTOL aerial vehicle 100A. Controlling the second manned VTOL aerial vehicle 100A may comprise causing the second manned VTOL aerial vehicle 100A to output the second user interface output. Therefore, in some embodiments, the at least one second processor 132A outputs the second user interface output. The at least one second processor 132A outputs the second user interface output using the second user interface 129A. The pilot may then control the second propulsion system 106A to land the second manned VTOL aerial vehicle 100A based on the second user interface output.

### Computer-Implemented Method 1200

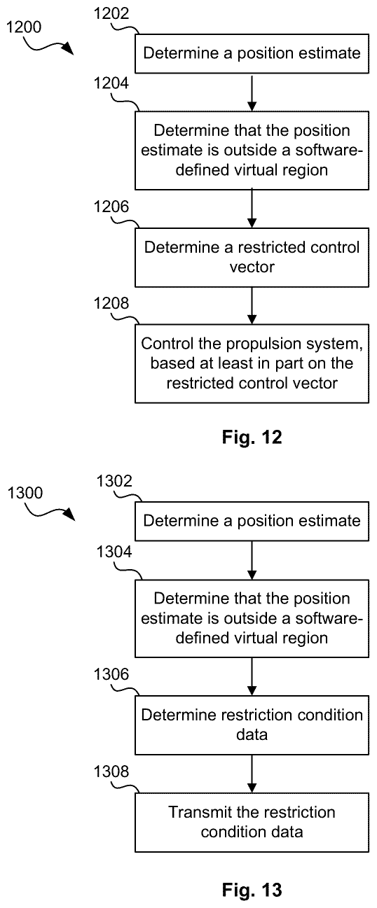

FIG. 12 is a process flow diagram illustrating a computer-implemented method 1200. In some embodiments, the computer-implemented method 1200 is for controlling the manned VTOL aerial vehicle 100. At least part of the computer-implemented method 1200 is performed by the manned VTOL aerial vehicle 100. In particular, at least part of the computer-implemented method 1200 is performed by the at least one processor 132 of the manned VTOL aerial vehicle.

FIG. 12 is to be understood as a blueprint for one or more software programs and may be implemented step-by-step, such that each step in FIG. 12 may, for example, be represented by a function in a programming language, such as C++, C, C#, Python or Java. The resulting source code is then compiled and stored as computer executable instructions on memory 134.

The manned VTOL aerial vehicle 100, as described herein, is configured to store vehicle data, and to transmit the vehicle data via the vehicle communication system 122. The vehicle data is associated with the manned VTOL aerial vehicle 100. In particular, the vehicle data is associated with one or more sub-systems of the manned VTOL aerial vehicle 100. For example, the vehicle data may comprise the sensor data, as described herein. The manned VTOL aerial vehicle 100 is also configured to receive data using the communication system 122. For example, the manned VTOL aerial vehicle 100 is configured to receive central server system data that is transmitted by the central server system 103. Similarly, the manned VTOL aerial vehicle 100 is configured to receive vehicle data that is transmitted by other vehicles (e.g. one or more of manned VTOL aerial vehicles 100A-N).

At 1202, the at least one processor 132 determines a position estimate. The position estimate is indicative of a position of the manned VTOL aerial vehicle 100 within a region around the manned VTOL aerial vehicle 100. The position of the manned VTOL aerial vehicle 100 may be indicative of a position of the manned VTOL aerial vehicle 100 within the region. The position estimate is indicative of the position of the manned VTOL aerial vehicle 100 at a particular time. The position estimate may also be indicative of a position of the manned VTOL aerial vehicle within the three-dimensional model of the region.

The at least one processor 132 may determine the position estimate based at least in part on the vehicle data. In particular, the at least one processor 132 may determine the position estimate based at least in part on the sensor data. For example, where the sensor data comprises GNSS data, the at least one processor 132 may determine the position estimate based at least in part on the GNSS data. The at least one processor 132 may determine the position estimate based at least in part on the external sensing system data. The at least one processor 132 may determine the position estimate based at least in part on the central server system data.

In some embodiments, the manned VTOL aerial vehicle 100 is configured to determine a position estimate confidence metric. In particular, the at least one processor 132 determines the position estimate confidence metric. The position estimate confidence metric is indicative of an error associated with the position estimate. The position estimate confidence metric may be referred to as a vehicle position estimate confidence metric.

The at least one processor 132 determines the position estimate confidence metric based at least in part on the vehicle data. The at least one processor 132 determines the position estimate confidence metric based at least in part on one of the inputs used to determine the position estimate (e.g. the vehicle data, the external sensing system data and/or the central server system data). For example, the at least one processor 132 may determine the position estimate confidence metric based at least in part on an error associated with one or more of the vehicle data, the external sensing system data and the central server system data.

At 1204, the at least one processor 132 compares the position estimate to a software-defined virtual region. In particular, the at least one processor 132 determines that the position estimate is outside of the software-defined virtual region. The software defined virtual region is a region of the three-dimensional model of the region that is stored in memory 134.

At 1206, the at least one processor 132 determines a restricted control vector. The at least one processor 132 determines the restricted control vector based at least in part on the determination that the position estimate is outside of the software-defined virtual region. The at least one processor 132 determines the restricted control vector based at least in part on the control vector and/or control restriction data received or determined by the control system 116. Control restriction data may have been previously received by control system 116 from central server system 103 and stored in control system memory 134, for example.

The control restriction data may define vehicle control restrictions in relation to vehicle performance in order to limit certain performance characteristics of the vehicle 100. For example, the control restriction data may define control restrictions in pitch angle, power supplied to the motors, motor tilt or other characteristics that can affect the flight of the vehicle 100 through the air. The control restrictions may further define limits in rates of change of performance characteristics, such as pitch angle, power supplied to the motors, motor tilt or other characteristics that can affect the flight of the vehicle 100 through the air.

The restricted control vector may comprise a pitch element, for example. The pitch element of the restricted control vector is associated with a maximum pitch angle. In particular, a value of the pitch element is associated with a maximum pitch angle at which the manned VTOL aerial vehicle 100 is enabled to manoeuvre.

In some embodiments, the at least one processor 132 reduces a maximum allowable magnitude of the pitch element in determining the restricted control vector. That is, under no restriction, the pitch element of the control vector can take a first maximum value. The at least one processor 132 reduces this to a second maximum value that is lower than the first maximum value when determining the restricted control vector.

In some embodiments, determining the restricted control vector comprises scaling a value of the pitch element of the control vector. That is, the at least one processor 132 scales the value of the pitch element of the control vector to determine the value of the pitch element of the restricted control vector. In particular, the least one processor 132 scales the value of the pitch element of the control vector by a scale factor that is less than one to determine the value of the pitch element of the restricted control vector.

The restricted control vector may comprise a power supply element, for example. The power supply element of the restricted control vector is associated with a maximum power to be supplied to each or all of the motors. In particular, a value of the power supply element is associated with a maximum power supply value for supply of power to the motors of the manned VTOL aerial vehicle 100.

In some embodiments, the at least one processor 132 reduces a maximum allowable magnitude of the power supply element in determining the restricted control vector. That is, under no restriction, the power supply element of the control vector can take a first maximum value. The at least one processor 132 reduces the value of the power supply element to a second maximum value that is lower than the first maximum value when determining the restricted control vector.

In some embodiments, determining the restricted control vector comprises scaling a value of the power supply element of the control vector. That is, the at least one processor 132 scales the value of the power supply element of the control vector to determine the value of the power supply element of the restricted control vector. In particular, the least one processor 132 scales the value of the power supply element of the control vector by a scale factor that is less than one to determine the value of the power supply element of the restricted control vector.

The restricted control vector may comprise a motor tilt element, for example. The motor tilt element of the restricted control vector is associated with a maximum tilt applied to each or all of the motors. In particular, a value of the motor tilt element is associated with a maximum motor tilt value for tilting the motors of the manned VTOL aerial vehicle 100.

In some embodiments, the at least one processor 132 reduces a maximum allowable magnitude of the motor tilt element in determining the restricted control vector. That is, under no restriction, the motor tilt element of the control vector can take a first maximum value. The at least one processor 132 reduces the value of the motor tilt element to a second maximum value that is lower than the first maximum value when determining the restricted control vector.

In some embodiments, determining the restricted control vector comprises scaling a value of the motor tilt element of the control vector. That is, the at least one processor 132 scales the value of the motor tilt element of the control vector to determine the value of the motor tilt element of the restricted control vector. In particular, the least one processor 132 scales the value of the motor tilt element of the control vector by a scale factor that is less than one to determine the value of the motor tilt element of the restricted control vector.

In some embodiments, the at least one processor 132 determines the restricted control vector such that one or more of a velocity, acceleration, pitch, yaw and roll of the manned VTOL aerial vehicle 100 is restricted.

At 1208, the at least one processor 132 controls the manned VTOL aerial vehicle 100, based at least in part on the restricted control vector. In particular, the at least one processor 132 controls the propulsion system 106 manned VTOL aerial vehicle 100 based at least in part on the restricted control vector.

In some embodiments, the at least one processor 132 determines a user interface output. The user interface output may be as described herein. That is, the user interface output comprises a visual output. For example, the user interface output may comprise a symbol that is displayed on the display of the manned VTOL aerial vehicle 100, indicating that the position estimate is outside the software-defined virtual region. An attribute (colour, position etc.) of the symbol on the display can be updated as the manned VTOL aerial vehicle 100 moves, and can guide the pilot back within the software-defined virtual region.

The user interface output comprises an audio output. For example, the user interface output may comprise a recorded message indicating that the pilot is outside the software-defined virtual region.

In some embodiments, the at least one processor 132 determines restriction data. The restriction data is associated with the restricted control vector. The restriction data may comprise the position estimate. The restriction data may also include a time value indicating a period of time during which the manned VTOL aerial vehicle 100 has been outside the software-defined virtual boundary.

The at least one processor 132 notifies the pilot of the restriction data. For example, the at least one processor 132 may determine a user interface output for display on the user interface 129, in response to determining the restriction data. Alternatively, the restriction data may comprise the user interface output. The user interface output may comprise a visual output. The user interface output may comprise an audio output.

The at least one processor 132 is configures to transmit the restriction data using the communication system 122. The central server system 103, one or more of the other manned VTOL aerial vehicles 100A-N and/or the autonomous vehicle 181 may receive the restriction data.

In some embodiments, the autonomous vehicle processor receives the restriction data. The autonomous vehicle processor receives the restriction data using the autonomous vehicle communication system. The autonomous vehicle processor controls the autonomous vehicle propulsion system based at least in part on the restriction data. For example, as described herein, the restriction data may comprise the position estimate. In some embodiments, the autonomous vehicle 181 may be a media vehicle comprising a camera, that is configured to record aspects of the region and transmit them for display (e.g. to an audience of a race). In cases such as this, the autonomous vehicle processor may control the autonomous vehicle propulsion system to travel towards the position estimate to observe the manned VTOL aerial vehicle 100.

### Computer-Implemented Method 1300

FIG. 13 is a process flow diagram illustrating a computer-implemented method 1300. In some embodiments, the computer-implemented method 1300 is for transmitting restriction condition data. At least part of the computer-implemented method 1300 is performed by the central server system 103. In particular, at least part of the computer-implemented method 1300 is performed by the at least one central server system processor 220.

FIG. 13 is to be understood as a blueprint for one or more software programs and may be implemented step-by-step, such that each step in FIG. 13 may, for example, be represented by a function in a programming language, such as C++, C, C#, Python or Java. The resulting source code is then compiled and stored as computer executable instructions. The computer executable instructions may be stored on central server system memory 222.

The manned VTOL aerial vehicle 100, as described herein, is configured to store vehicle data, and to transmit the vehicle data via the vehicle communication system 122. The vehicle data is associated with the manned VTOL aerial vehicle 100. In particular, the vehicle data is associated with one or more sub-systems of the manned VTOL aerial vehicle 100. For example, the vehicle data may comprise the sensor data, as described herein. The manned VTOL aerial vehicle 100 is also configured to receive data using the communication system 122. For example, the manned VTOL aerial vehicle 100 is configured to receive central server system data that is transmitted by the central server system 103. Similarly, the manned VTOL aerial vehicle 100 is configured to receive vehicle data that is transmitted by other vehicles (e.g. one or more of manned VTOL aerial vehicles 100A-N).

The central server system 103, as described herein, is configured to receive the vehicle data and to store the vehicle data in central server system memory 222. The central server system 103 is configured to store the external sensing system data in central server system memory 222, as described herein. The central server system 103 is configured to store the three-dimensional model of the region in central server system memory 222, as described herein.

At 1302, the at least one central server system processor 220 determines a position estimate. The position estimate is indicative of a position of the manned VTOL aerial vehicle 100 within a region around the manned VTOL aerial vehicle 100. The position of the manned VTOL aerial vehicle 100 may be indicative of a position of the manned VTOL aerial vehicle 100 within the region. The position estimate is indicative of the position of the manned VTOL aerial vehicle 100 at a particular time. The position estimate is also indicative of a position of the manned VTOL aerial vehicle 100 within the three-dimensional model of the region, as described herein.

The at least one central server system processor 220 may determine the position estimate based at least in part on the vehicle data. In particular, the at least one central server system processor 220 may determine the position estimate based at least in part on the sensor data. For example, where the sensor data comprises GNSS data, the at least one central server system processor 220 may determine the position estimate based at least in part on the GNSS data. The at least one central server system processor 220 may determine the position estimate based at least in part on the external sensing system data. The at least one central server system processor 220 may determine the position estimate based at least in part on the central server system data.

In some embodiments, the at least one central server system processor 220 determines a position estimate confidence metric. The position estimate confidence metric is indicative of an error associated with the position estimate. The position estimate confidence metric may be referred to as a vehicle position estimate confidence metric.

The at least one central server system processor 220 determines the position estimate confidence metric based at least in part on one or more of the vehicle data, the external sensing system data and the central server system data. The at least one central server system processor 220 determines the position estimate confidence metric based at least in part on one of the inputs used to determine the position estimate (e.g. the vehicle data, the external sensing system data and the central server system data). For example, the at least one central server system processor 220 may determine the position estimate confidence metric based at least in part on an error associated with one or more of the vehicle data, the external sensing system data and the central server system data.

At 1304, the at least one central server system processor 220 compares the position estimate of a vehicle 100 to a software-defined virtual region. In particular, the at least one central server system processor 220 determines that the position estimate is outside of the software-defined virtual region. The software defined virtual region is a region of the three-dimensional model of the region that is stored in central server system memory 222. In some embodiments, a separate server from the central server system 103 (but still forming part of system 101) may be used to monitor positions of vehicles 100 relative to software-defined virtual regions (including the track 230) and to determine compliance with virtual flight boundaries or conditions. In some embodiments, the separate server of system 101 may be used to monitor positions of vehicles 100 relative to the track 230 and to determine obstacle collision probabilities of each vehicle 100 with virtual or real objects. The separate server can then communicate the determined compliance information or obstacle collision probabilities to the respective vehicle 100 directly, through central server system 103 or through another communication path defined in the system 101.

At 1306, the at least one central server system processor 220 determines restriction condition data. The at least one central server system processor 220 determines the restriction condition data based at least in part on the determination that the position estimate of one of the vehicles 100 is outside of the software-defined virtual region. The restriction condition data may comprise instructions to determine a restriction control vector and operate the vehicle 100 based at least in part on the restriction control vector. The restriction control vector may be determined based on control restriction data.

The restriction condition data may comprise the restriction control vector itself. In some embodiments, the vehicle data comprises the control vector. The at least one central server system processor 220 determines the restricted control vector based at least in part on the control vector.

The restricted control vector may comprise a pitch element, a power supply element, a motor tilt element or another performance characteristic element that can affect flight of the vehicle 100 through the air, for example. The pitch element is associated with a maximum pitch angle. In particular, a value of the pitch element is associated with a maximum pitch angle at which the manned VTOL aerial vehicle 100 is enabled to manoeuvre. The power supply element of the restricted control vector is associated with a maximum power to be supplied to each or all of the motors. In particular, a value of the power supply element is associated with a maximum power supply value for supply of power to the motors of the manned VTOL aerial vehicle 100. The motor tilt element of the restricted control vector is associated with a maximum tilt applied to each or all of the motors. In particular, a value of the motor tilt element is associated with a maximum motor tilt value for tilting the motors of the manned VTOL aerial vehicle 100.

The at least one central server system processor 220 reduces a maximum allowable magnitude of one or more of the pitch element, the power supply element, the motor tilt element or the other performance characteristic element in determining the restricted control vector. That is, under no restriction, a value of the pitch element, the power supply element, the motor tilt element or the other performance characteristic element can take a first maximum value. The at least one central server system processor 220 reduces this to a second maximum value that is lower than the first maximum value when determining the restricted control vector.

In some embodiments, determining the restricted control vector comprises scaling a value of one or more of the pitch element, the power supply element, the motor tilt element or the other performance characteristic element of the control vector. That is, the at least one central server system processor 220 scales the value of one or more of the pitch element, the power supply element, the motor tilt element or the other performance characteristic element of the control vector to determine the value of the pitch element, the power supply element, the motor tilt element or the other performance characteristic element of the restricted control vector. In particular, central server system processor 220 scales the value of one or more of the pitch element, the power supply element, the motor tilt element or the other performance characteristic element of the control vector by a scale factor that is less than one to determine the value of the pitch element, the power supply element, the motor tilt element or the other performance characteristic element of the restricted control vector.

In some embodiments, the at least one central server system processor 220 determines the restriction condition data such that one or more of a velocity, acceleration, pitch, yaw and roll of the manned VTOL aerial vehicle 100 is restricted.

In some embodiments, the restriction condition data comprises a maximum value for one or more of the elements of the restriction control vector.

At 1308, the at least one central server system processor 220 transmits the restriction condition data. In particular, central server system processor 220 transmits the restriction condition data using the central server system communication system 226.

The manned VTO aerial vehicle 100 receives the restriction condition data. In particular, the at least one processor 132 receives the restriction condition data. The at least one processor 132 controls the manned VTOL aerial vehicle 100, based at least in part on the restricted condition data.

In embodiments where the restriction condition data comprises instructions to determine the restricted control vector, the at least one processor 132 may determine the restricted control vector as described herein, for example, with respect to the computer-implemented method 1200, and control the manned VTOL aerial vehicle 100 accordingly.

In embodiments where the restriction condition data comprises the restricted control vector, the at least one processor 132 may control the propulsion system 106 of the manned VTOL aerial vehicle 100 based at least in part on the restricted control vector.

In embodiments where the restriction condition data comprises a maximum value for one or more of the elements of the restriction control vector, the at least one processor 132 may determine the restriction control vector based on the control vector and the maximum value.

In some embodiments, the at least one central server system processor 220 determines a user interface output. The restriction condition data may comprise the user interface output. The user interface output may be as described herein. That is, the user interface output comprises a visual output. For example, the user interface output may comprise a symbol that is displayed on the display of the manned VTOL aerial vehicle 100, indicating that the position estimate is outside the software-defined virtual region. An attribute (e.g. a colour, position etc.) of the symbol on the display can be updated as the manned VTOL aerial vehicle 100 moves, and can guide the pilot back within the software-defined virtual region.

The user interface output comprises an audio output. For example, the user interface output may comprise a recorded message indicating that the pilot is outside the software-defined virtual region.

In some embodiments, the autonomous vehicle processor receives the restriction condition data. The autonomous vehicle processor receives the restriction condition data using the autonomous vehicle communication system. The autonomous vehicle processor controls the autonomous vehicle propulsion system based at least in part on the restriction condition data. For example, as described herein, the restriction condition data may comprise the position estimate. In some embodiments, the autonomous vehicle 181 may be a media vehicle comprising a camera, that is configured to record aspects of the region and transmit them for display (e.g. to an audience of a race). In cases such as this, the autonomous vehicle processor may control the autonomous vehicle propulsion system to travel towards the position estimate to observe the manned VTOL aerial vehicle 100.

### Alternative Control System 116 Architecture

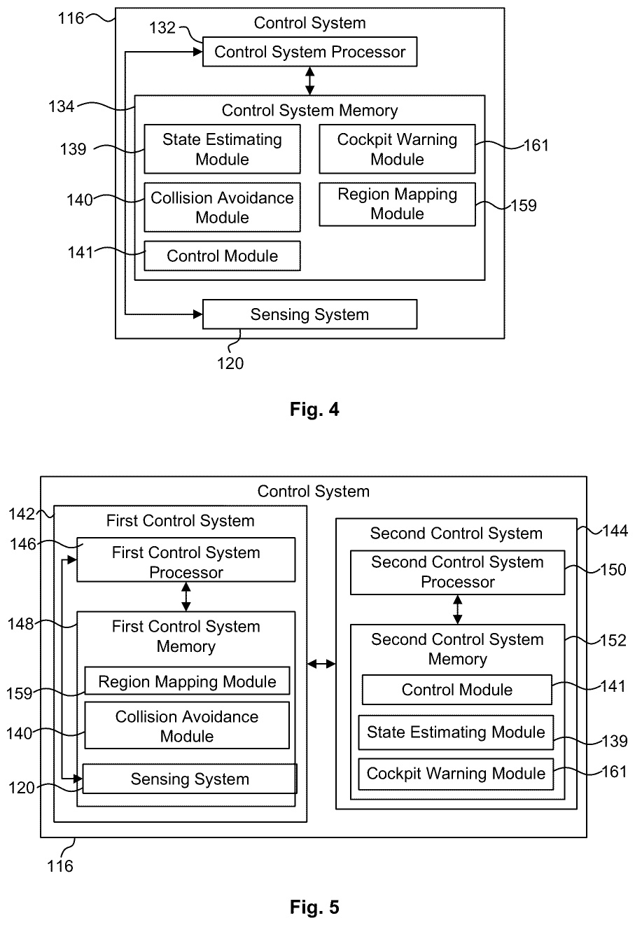

Although the manned VTOL aerial vehicle 100 has been described with reference to the control system 116 of FIG. 4, it will be understood that the manned VTOL aerial vehicle 100 may comprise alternative control system 116 architecture. FIG. 5 illustrates an alternative control system 116, according to some embodiments.

FIG. 5 is a block diagram of the control system 116, according to some embodiments. The control system 116 illustrated in FIG. 5 comprises a first control system 142 and a second control system 144. The first control system 142 comprises at least one first control system processor 146. The at least one first control system processor 146 is configured to be in communication with first control system memory 148. The first control system 142 comprises the sensing system 120. The sensing system 120 may be as described herein. The sensing system 120 is configured to communicate with the at least one first control system processor 146. In some embodiments, the sensing system 120 is configured to provide the sensor data to the at least one first control system processor 146. In some embodiments, the at least one first control system processor 146 is configured to receive the sensor data from the sensing system 120. In some embodiments, the at least one first control system processor 146 is configured to retrieve the sensor data from the sensing system 120. The at least one first control system processor 146 is configured to store the sensor data in the first control system memory 148.

The at least one first control system processor 146 is configured to execute first control system program instructions stored in first control system memory 148 to cause the first control system 142 to function as described herein. In particular, the at least one first control system processor 146 is configured to execute the first control system program instructions to cause the manned VTOL aerial vehicle 100 to function as described herein. In other words, the first control system program instructions are accessible by the at least one first control system processor 146, and are configured to cause the at least one first control system processor 146 to function as described herein.

In some embodiments, the first control system program instructions are in the form of program code. The at least one first control system processor 146 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The first control system program instructions comprise the region mapping module 159 and the collision avoidance module 140.

First control system memory 148 may comprise one or more volatile or non-volatile memory types. For example, first control system memory 148 may comprise one or more of random access memory (RAM), read-only memory (ROM), electrically erasable programmable read-only memory (EEPROM) or flash memory. First control system memory 148 is configured to store program code accessible by the at least one first control system processor 146. The program code may comprise executable program code modules. In other words, first control system memory 148 is configured to store executable code modules configured to be executable by the at least one first control system processor 146. The executable code modules, when executed by the at least one first control system processor 146 cause the at least one first control system processor 146 to perform certain functionality, as described herein. In the illustrated embodiment, the region mapping module 159 and the collision avoidance module 140 are in the form of program code stored in the first control system memory 138.

The second control system 144 comprises at least one second control system processor 150. The at least one second control system processor 150 is configured to be in communication with second control system memory 152. The at least one second control system processor 150 is configured to execute second control system program instructions stored in second control system memory 152 to cause the second control system 144 to function as described herein. In particular, the at least one second control system processor 150 is configured to execute the second control system program instructions to cause the manned VTOL aerial vehicle 100 to function as described herein. In other words, the second control system program instructions are accessible by the at least one second control system processor 150, and are configured to cause the at least one second control system processor 150 to function as described herein.

In some embodiments, the second control system 144 comprises some or all of the sensing system 120. The control system 120 may be as previously described. The sensing system 120 is configured to communicate with the at least one second control system processor 150. In some embodiments, the sensing system 120 is configured to provide the sensor data to the at least one second control system processor 150. In some embodiments, the at least one second control system processor 150 is configured to receive the sensor data from the sensing system 120. In some embodiments, the at least one second control system processor 150 is configured to retrieve the sensor data from the sensing system 120. The at least one second control system processor 150 is configured to store the sensor data in the second control system memory 152.

In some embodiments, the second control system program instructions are in the form of program code. The at least one second control system processor 150 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The second control system program instructions comprise the state estimating module 139, the cockpit warning module 161 and the control module 141.

Second control system memory 152 may comprise one or more volatile or non-volatile memory types. For example, second control system memory 152 may comprise one or more of random access memory (RAM), read-only memory (ROM), electrically erasable programmable read-only memory (EEPROM) or flash memory. Second control system memory 152 is configured to store program code accessible by the at least one second control system processor 150. The program code may comprise executable program code modules. In other words, second control system memory 152 is configured to store executable code modules configured to be executable by the at least one second control system processor 150. The executable code modules, when executed by the at least second control system processor 150 cause the at least one second control system processor 150 to perform certain functionality, as described herein. In the illustrated embodiment, the state estimating module 139, the cockpit warning module 161 and the control module 141 are in the form of program code stored in the second control system memory 152.

The first control system 142 is configured to communicate with the second control system 144. The first control system 142 may comprise a first control system network interface (not shown). The first control system network interface is configured to enable the first control system 142 to communicate with the second control system 144 over one or more communication networks. In particular, the first control system processor 146 may be configured to communicate with the second control system processor 150 using the first control system network interface. The first control system 142 may comprise a combination of network interface hardware and network interface software suitable for establishing, maintaining and facilitating communication over a relevant communication channel. Examples of a suitable communication network include a communication bus, cloud server network, wired or wireless network connection, cellular network connection, dedicated short-range communications (DSRC) (e.g. IEEE 802.11p), Bluetooth™ or other near field radio communication, and/or physical media such as a Universal Serial Bus (USB) connection.

The second control system 144 may comprise a second control system network interface (not shown). The second control system network interface is configured to enable the second control system 144 to communicate with the first control system 142 over one or more communication networks. In particular, the second control system processor 150 may be configured to communicate with the first control system processor 146 using the second control system network interface. The second control system 144 may comprise a combination of network interface hardware and network interface software suitable for establishing, maintaining and facilitating communication over a relevant communication channel. Examples of a suitable communication network include a communication bus, cloud server network, wired or wireless network connection, cellular network connection, dedicated short-range communications (DSRC) (e.g. IEEE 802.11p), Bluetooth™ or other near field radio communication, and/or physical media such as a Universal Serial Bus (USB) connection.

The first control system 142 may be considered a high-level control system. That is, the first control system 142 may be configured to perform computationally expensive tasks. The second control system 144 may be considered a low-level control system. The second control system 144 may be configured to perform computationally less-expensive tasks than the first control system 144.

### Alternative Piloting System

In some embodiments, the manned VTOL aerial vehicle 100 may be piloted remotely. That is, the manned VTOL aerial vehicle 100 may comprise a remote cockpit 104. In other words, the cockpit 104 may be in the form of a remote cockpit 104. The remote cockpit 104 may be in a different location to that of the manned VTOL aerial vehicle 100. For example, the remote cockpit 104 may be in a room that is separated from the manned VTOL aerial vehicle 100 (e.g. a cockpit replica ground station).

The remote cockpit 104 can be similar or identical to the cockpit 104. That is, the remote cockpit 104 may comprise user interface 129. The remote cockpit 104 may comprise the pilot-operable controls 118. The remote cockpit 104 comprises at least one display. The display is configured to display at least some of the vehicle data transmitted by the manned VTOL aerial vehicle 100. For example, the display is configured to display one or more of the visible spectrum image data, vehicle position estimate, vehicle state estimate, vehicle state estimate confidence metric, object state estimate, object state estimate confidence metric, GNSS data, altitude data, accelerometer data, gyroscopic data, magnetic field data, LIDAR data and RADAR data, or a portion thereof.

The remote cockpit 104 may comprise a remote cockpit communication system. The remote cockpit communication system is configured to enable the remote cockpit 104 to communicate with the manned VTOL aerial vehicle 100. For example, the remote cockpit 104 may communicate with the manned VTOL aerial vehicle 100 via a radio frequency link. In some embodiments, the remote cockpit 104 may communicate with the manned VTOL aerial vehicle 100 using the communication network 105. The remote cockpit 104 may provide the input vector to the manned VTOL aerial vehicle 100. In particular, the at least one processor 132 (or the control system 116) may receive the input vector from the remote cockpit 104.

The manned VTOL aerial vehicle 100 is configured to communicate with the remote cockpit 104 using the communication system 122. The manned VTOL aerial vehicle 100 may be configured to communicate with the remote cockpit 104 via the radio frequency link and/or the communication network 105. The manned VTOL aerial vehicle 100 is configured to provide vehicle data to the remote cockpit 104. For example, the manned VTOL aerial vehicle 100 is configured to provide a video feed and/or telemetry data to the remote cockpit 104. The remote cockpit 104 may comprise a cockpit display configured to display the video feed and/or telemetry data for the pilot.

### Operation of the Manned VTOL Aerial Vehicle 100 Via the Central Server System 103

In some embodiments, the manned VTOL aerial vehicle 100 comprises the pilot operable controls 118 and the central server system 103 comprises the remote cockpit 104. Both the pilot-operable controls 118 and the remote cockpit 104 may be used to control the manned VTOL aerial vehicle 100. For example, the remote cockpit 104 may be configured to receive inputs from a supervising operator. The manned VTOL aerial vehicle 100 may be configured to operate in accordance with the inputs from the supervising operator received via the remote cockpit 104.

In some embodiments, the central server system 103 comprises a user interface (not shown). The user interface comprises a display that is configured to display information, such as a graphical user interface, to the supervising operator. The display may comprise one or more LCD, LED, OLED, plasma, cathode-ray or other displays. The display may be or include a touch-screen display. The user interface comprises an input device. The input device may comprise one or more buttons, switches, keyboards, digital mice, joysticks, microphones, touch-screens or other input devices. The input device is configured to communicate one or more inputs provided by the supervising operator to the central server system 103. The manned VTOL aerial vehicle 100 may be configured to operate in accordance with the inputs from the supervising operator received via the user interface.

The remote cockpit 104 and/or the user interface may be used by the supervising operator to generate and/or provide warnings or messages to the manned VTOL aerial vehicle 100 and/or the pilot of the manned VTOL aerial vehicle 100. Similarly, the remote cockpit 104 and/or the user interface may be used by the supervising operator to create, modify or remove virtual boundaries of the region, parameters associated with virtual objects and/or no-fly zones. The remote cockpit 104 and/or the user interface may be used by the supervising operator to send high level commands to the manned VTOL aerial vehicle 100 to, for example, change a flight mode of the manned VTOL aerial vehicle, change performance of the manned VTOL aerial vehicle 100 (e.g. to introduce a maximum velocity threshold) or change another parameter associated with the manned VTOL aerial vehicle 100.

In some embodiments, the central server system 103 comprises a plurality of remote cockpits 104 and/or user interfaces. In some embodiments, the central server system 103 comprises a plurality of displays. Each of the plurality of displays is configured to display information associated with the manned VTOL aerial vehicle 100 and/or the central server system 103 (e.g. the vehicle data, wireless information etc.).

In some embodiments, the inputs received via the pilot-operable controls 118 are associated with a first priority. The first priority may be a number (e.g. between 0 and 1). The first priority is indicative of a priority of the inputs received via the pilot-operable controls 118. The inputs received via the remote cockpit 104 are associated with a second priority. The second priority may be a number (e.g. between 0 and 1). The second priority is indicative of a priority of the inputs received via the remote cockpit 104. The manned VTOL aerial vehicle 100 may priorities the inputs received via the pilot-operable controls 118 and the inputs received via the remote cockpit 104 based at least in part on the first priority and/or the second priority. For example, where the first priority is greater than the second priority, the manned VTOL aerial vehicle 100 may prioritise the inputs received via the pilot-operable controls 118. Similarly, where the second priority is greater than the first priority, the manned VTOL aerial vehicle 100 may prioritise inputs received via the remote cockpit 104. In some embodiments, the first priority may be associated with a first weighting that is applied to the inputs received via the pilot-operable controls 118. In some embodiments, the second priority may be associated with a second weighting that is applied to the inputs received via the remote cockpit 104.

### Unmanned VTOL Aerial Vehicle

In some embodiments, the manned VTOL aerial vehicle 100 may instead be an unmanned VTOL aerial vehicle. In such a case, the unmanned VTOL aerial vehicle may not include the cockpit 104. Furthermore, the pilot-operable control system 118 may be remote to the unmanned VTOL aerial vehicle. Alternatively, the unmanned VTOL aerial vehicle may be an autonomous unmanned VTOL aerial vehicle.

In some embodiments, the manned VTOL aerial vehicle 100 may be autonomously controlled. For example, the manned VTOL aerial vehicle 100 may be autonomously controlled during take-off and landing. The control system 116 may autonomously control the manned VTOL aerial vehicle 100 during these phases. In other words, the manned VTOL aerial vehicle 100 may be configured to be autonomously or manually switched between a fully autonomous control mode, in which pilot input to the pilot-operable controls is ignored for flight control purposes, and a shared control mode, in which the pilot can assume manual flight control of the vehicle 100 within an overall autonomous collision-avoidance control program.

### Use of Visible Landmarks

In some embodiments, the manned VTOL aerial vehicle 100 is configured to use visible landmarks to assist with localisation or other functionality. Localisation may include position, velocity, attitude and/or angular rate estimation, or estimation of other characteristics of the manned VTOL aerial vehicle 100. For example, a fixed landmark (i.e. a landmark that does not move) may be associated with a landmark position. The landmark position is indicative of a position of the landmark within a landmark coordinate system. The landmark coordinate system may correspond with the global coordinate system as previously described. Alternatively, the landmark coordinate system may correspond with a local coordinate system of the region described herein. In some embodiments, dynamic landmarks may also be used. Dynamic landmarks are landmarks for which a property is dynamic. For example, the position of a dynamic landmark may change with time.

Where the landmark is detected by one or more of the sensors of the sensing system 120, the manned VTOL aerial vehicle 100 is configured to determine the position estimate, or a state estimate based at least in part on the detected landmark. Examples of landmarks include lines, lights, smoke or natural features such as trees. Other functionality, such as autonomous or semi-autonomous functionality may also be optimised based at least in part on the detected landmark. For example, the landmark may be indicative of a position of an emergency landing area, a nominal take off and/or landing area or a pit area.

It will be understood that for the purposes of this disclosure, that “manned” when referred to in the context of the manned VTOL aerial vehicle 100 is a configuration of the vehicle, rather than a state of the vehicle. That is, a pilot is not required at all times for the manned VTOL aerial vehicle 100 to be considered to be manned. The manned VTOL aerial vehicle 100 may be considered to be manned, at least because it comprises the pilot-operable controls 118 that are configured to be operated by the pilot. While the manned VTOL aerial vehicle 100 may be operated remotely, for example, via the remote cockpit 104, it is still appropriate to consider the manned VTOL aerial vehicle 100 as manned, as it comprises the pilot-operable controls 118.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A central server system comprising:
at least one central server system processor; and
central server system memory storing central server system program instructions accessible by the at least one central server system processor, and configured to cause the at least one central server system processor to:
receive vehicle registration data associated with a manned VTOL aerial vehicle; and
determine that the vehicle registration data is associated with a manned VTOL aerial vehicle that is authorized to communicate with the central server system.

2. The central server system of claim 1, further comprising a central server system communication system;
wherein the central server system program instructions are further configured to cause the at least one central server system processor to receive the vehicle registration data using the central server system communication system.

3. The central server system of claim 1, wherein:
the vehicle registration data comprises one or more of vehicle identification data and vehicle performance data; and
the vehicle performance data comprises one or more of vehicle sensor data, vehicle diagnostic data, vehicle firmware data and pilot biometric data.

4. The central server system of claim 1, wherein, in response to determining that the manned VTOL aerial vehicle is authorized to communicate with the central server system, the central server system program instructions are configured to cause the at least one central server system processor to determine central server system data; and
wherein the central server system program instructions are further configured to cause the at least one central server system processor to transmit the central server system data to the manned VTOL aerial vehicle.

5.-6. (canceled)

7. The central server system of claim 4, wherein:
the central server system memory stores a three-dimensional model of a region; and
the central server system data comprises an updated three-dimensional model of the region.

8. The central server system of claim 4, wherein the central server system data comprises an object state estimate that is indicative of a state of an object; and
wherein the central server system data comprises an object state estimate confidence metric that is indicative of an error associated with the object state estimate.

9. (canceled)

10. The central server system of claim 1, wherein the central server system data comprises vehicle control data configured to be executed by the at least one processor to control the manned VTOL aerial vehicle.

11. The central server system of claim 3, wherein:
the central server system program instructions are configured to cause the at least one central server system processor to:
compare the vehicle performance data to an operational condition;
determine that the vehicle registration data satisfies the operational condition; and
determine a vehicle landing position vector; and
the central server system data comprises the vehicle landing position vector.

12.-21. (canceled)

22. A manned VTOL aerial vehicle comprising:
a body comprising a cockpit;
a propulsion system carried by the body to propel the body during flight;
pilot-operable controls accessible from the cockpit; and
a control system configured to receive input from the pilot-operable controls and to perform autonomous control functions, the control system comprising:
at least one processor; and
memory storing program instructions accessible by the at least one processor, and configured to cause the at least one processor to:
determine that vehicle data satisfies an operational condition;
determine a landing position vector in response to determining that the vehicle data satisfies the operational condition; and
autonomously control the propulsion system to land the manned VTOL aerial vehicle within a landing zone that is associated with the landing position vector.

23. A manned VTOL aerial vehicle comprising:
a body comprising a cockpit;
a propulsion system carried by the body to propel the body during flight;
a user interface comprising pilot-operable controls accessible from the cockpit; and
a control system comprising:
at least one processor; and
memory storing program instructions accessible by the at least one processor, and configured to cause the at least one processor to:
determine that vehicle data satisfies an operational condition;
determine a landing position vector in response to determining that the vehicle data satisfies the operational condition;
determine a user interface output based at least in part on the landing position vector; and
output the user interface output using the user interface.

24. The manned VTOL aerial vehicle of claim 23, wherein the user interface output comprises one or more of an audio output and a visual output.

25. The manned VTOL aerial vehicle of claim 22, wherein the vehicle data is associated with the manned VTOL aerial vehicle.

26. The manned VTOL aerial vehicle of claim 22, further comprising a vehicle communication system; and
wherein the program instructions are further configured to cause the at least one processor to transmit the vehicle data using the vehicle communication system.

27. (canceled)

28. The manned VTOL aerial vehicle of claim 22, wherein the program instructions are further configured to cause the at least one processor to determine vehicle transmission data, the vehicle transmission data being indicative of the vehicle data satisfying the operational condition; and
wherein the vehicle transmission data comprises the landing position vector.

29.-43. (canceled)

44. A central server system comprising:
a central server system communication system;
at least one central server system processor; and
central server system memory storing central server system program instructions accessible by the at least one central server system processor, and configured to cause the at least one central server system processor to:
receive vehicle data that is associated with a manned VTOL aerial vehicle;
determine that the vehicle data satisfies an operational condition;
determine central server system data in response to determining that the vehicle data satisfies an operational condition; and
transmit the central server system data, to the manned VTOL aerial vehicle, using the central server system communication system.

45. The central server system of claim 44, wherein the central server system data comprises a landing position vector.

46. The central server system of claim 45, wherein:
the central server system memory stores a three-dimensional model of a region;
the central server system data comprises an updated three-dimensional model of the region; and
wherein the central server system program instructions are configured to cause the at least one central server system processor to determine the updated three-dimensional model of the region based at least in part on the landing position vector.

47. (canceled)

48. The central server system of claim 45, wherein the central server system data comprises restriction condition data.

49. The central server system of claim 48, wherein the central server system program instructions are configured to cause the at least one central server system processor to determine the restriction condition data based at least in part on the landing position vector.

50. The central server system of any one of claim 45, wherein the central server system data comprises a user interface output; and
wherein the central server system program instructions are configured to cause the at least one central server system processor to determine the user interface output based at least in part on the landing position vector.

51.-84. (canceled)
